(19) United States
(12) Patent Application Publication
(10) Pub. No.: US 2026/0331139 A1
(43) Pub. Date: Oct. 22, 2026

(54) AUDIO AND VIDEO SIGNAL PROCESSING SYSTEM SUPPORTING MULTIPLE PROCESSING RATES, MODALITIES, AND OUTPUT MIXES

(71) Applicant: Shure Acquisition Holdings, Inc., Niles, IL (US)

(72) Inventors: Devansh Zurale, Niles, IL (US); Michael Lester, Buena Vista, CO (US); Iris Lorente, Park Ridge, IL (US); Alex Mitchell, Niles, IL (US); Beth McDonald, Niles, IL (US); Daniel Law, Niles, IL (US); Ian Yan, Niles, IL (US); Jon Halverson, Niles, IL (US)

(21) Appl. No.: 19/655,535

(22) Filed: Apr. 22, 2026

Related U.S. Application Data
(60) Provisional application No. 63/792,569, filed on Apr. 22, 2025.
(60) Provisional application No. 63/882,861, filed on Sep. 16, 2025.

(51) Int. Cl. G11B 27/031; H04N 5/265

(52) U.S. Cl. CPC G11B 27/031; H04N 5/265

(57) ABSTRACT

An apparatus receives a plurality of multichannel data streams, generates per-channel embeddings for each stream using an embedding model and projection layers with different modification rates, generates inter-channel contextual embeddings using a contextual embedding model, generates predicted mix parameters by inputting the inter-channel contextual embeddings and global conditioning data to a mix parameter prediction network, applies the predicted mix parameters to the multichannel data streams to generate a mixed output stream, and outputs the mixed output stream. The apparatus enables multi-rate, multi-modal processing of audio and video inputs to produce customized mixes for different applications. Embodiments may be configured to achieve zero latency processing by implementing a predictive approach where mix parameters are applied with temporal offset.

### CROSS-REFERENCE TO RELATED APPLICATIONS

This application claims priority to U.S. Provisional Application Ser. No. 63/792,569, filed Apr. 22, 2025, and to U.S. Provisional Application Ser. No. 63/882,861, filed Sep. 16, 2025, the entire contents of both of which are incorporated herein by reference.

### TECHNICAL FIELD

The present disclosure relates to audio and video signal processing systems, and more particularly to an artificial intelligence-based mixing system that supports multiple processing rates, input modalities, and output mix types for live and studio applications.

### BACKGROUND

Audio mixing for live performances presents significant challenges due to the complex interactions between multiple sound sources, room acoustics, and audience dynamics. Through applied ingenuity, the inventors have developed solutions to such drawbacks, as disclosed herein.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Embodiments addresses complex technical challenges in audio and/or video mixing, particularly for live performances and multi-channel audio processing. One aspect of the system is multi-rate processing capability, which allows for the generation of embeddings based on features that are updated at different rates. This approach enables more efficient and accurate processing of audio signals by adapting to the varying temporal characteristics of different audio features.

The foregoing general description of the illustrative embodiments and the following detailed description thereof are merely exemplary aspects of the teachings of this disclosure and are not restrictive.

### BRIEF DESCRIPTION OF FIGURES

Having thus described some embodiments in general terms, reference will now be made to the accompanying drawings, which are not necessarily drawn to scale, and wherein:

FIG. 1 illustrates a block diagram of an example live performance audio mixing system, according to embodiments of the present disclosure;

FIG. 2 illustrates a block diagram of an example live performance music mixing system, according to embodiments of the present disclosure;

FIG. 3 illustrates a block diagram of an example instrument signal chain;

FIG. 4 illustrates a block diagram of an example multi-rate, multi-modality, multi-use processing system, according to embodiments of the present disclosure.

FIG. 5A illustrates a flowchart of an example multi-rate, multi-modality, multi-use processing system, according to embodiments of the present disclosure;

FIG. 5B illustrates a block diagram of an example multi-rate, multi-modality, multi-use processing system, according to embodiments of the present disclosure;

FIG. 6 depicts an example embedding model for use with embodiments of the present disclosure;

FIG. 7 depicts a block diagram of example multi-use mixing for use with embodiments of the present disclosure;

FIG. 8 illustrates a block diagram of an example generative AI mixing user workflow, according to embodiments of the present disclosure;

FIG. 9 illustrates a block diagram of an example generative AI mixer using source separation, according to embodiments of the present disclosure;

FIG. 10 illustrates a block diagram of an example multi-rate, multi-modality, multi-use processing system, according to embodiments of the present disclosure; and

FIG. 11 illustrates example multi-rate processing for a single channel, according to embodiments of the present disclosure.

FIG. 12 illustrates an example apparatus, according to embodiments of the present disclosure.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

Modern audio and video production environments present significant technical challenges in processing and mixing multiple input signals to create high-quality output mixes. These challenges arise from the complexity of handling diverse input sources, varying processing requirements, and a desire to generate multiple output mixes tailored for different purposes and playback environments.

One technical problem faced by audio and video signal processing systems is the need for multi-rate processing of input signals. Different aspects of audio and video signals change at different rates, requiring a system that can efficiently process both slowly changing and rapidly changing features. For example, certain characteristics like source locations or instrument identities may remain relatively constant over longer time periods, while other features such as signal amplitude or spectral content can change rapidly.

Another challenge faced by audio and video signal processing systems is incorporating multi-modal input features to inform the mixing process. Modern production environments may have access to various data sources beyond just audio signals, such as video feeds, positional data of performers, or contextual information about the performance venue. Effectively integrating these diverse input modalities to improve mixing decisions presents a complex technical problem.

Another challenge faced by audio and video signal processing systems is simultaneously producing multiple types of output mixes from the same set of input signals, especially in the context of a live performance environment. Different use cases, such as front-of-house sound reinforcement, on-stage monitor mixes for performers, and post-production mixes for recording or broadcast, each have unique requirements. Creating a system that can generate these varied output types concurrently, while optimizing for the specific needs of each, is a significant technical hurdle.

To address these challenges and more, advanced audio and video processing systems of the present disclosure may employ sophisticated algorithms to predict mix parameters based on analysis of the input signals and additional contextual data. These predicted parameters may include gain levels, panning positions, equalization settings, and effects parameters for each input channel. By generating these parameters computationally, the system can rapidly adapt to changing input conditions and produce consistent, high-quality mixes.

The ability to predict mix parameters, rather than directly manipulating the audio, also enables greater flexibility and user control. In some cases, the system may allow users to adjust or override the predicted parameters, providing a balance between automated efficiency and human creative input.

To handle the multi-rate processing requirements, the system may employ parallel processing paths for different types of features. In some cases, one path may process slowly changing features at a lower rate, while another path handles rapidly changing features at a higher rate. This approach allows for efficient use of computational resources while still capturing both long-term and short-term signal characteristics.

For multi-modal input processing, the system may use advanced machine learning techniques to fuse information from various sources. This may involve extracting relevant features from each modality and combining them in a way that enhances the overall understanding of the performance context and informs mixing decisions.

To address the need for multiple output mix types, the system may employ a flexible architecture that can generate different mixes simultaneously. In some cases, this may involve predicting separate sets of mix parameters for each output type, taking into account the specific requirements of front-of-house, monitor, and post-production mixes. The system may be capable of producing mono, stereo, multichannel, and spatial mixes to suit various playback scenarios.

Furthermore, the system may be designed to optimize mixes for different playback environments. This may involve analyzing the acoustic characteristics of the target playback space and adjusting mix parameters accordingly. In some cases, the system may generate multiple versions of the output mix, each tailored for a specific playback scenario such as headphone listening, car audio systems, or home theater setups.

By addressing these technical challenges, advanced audio and video signal processing systems can provide powerful tools for modern production environments. These systems may offer improved efficiency, consistency, and flexibility in creating high-quality mixes for a wide range of applications and playback scenarios.

### Example Systems

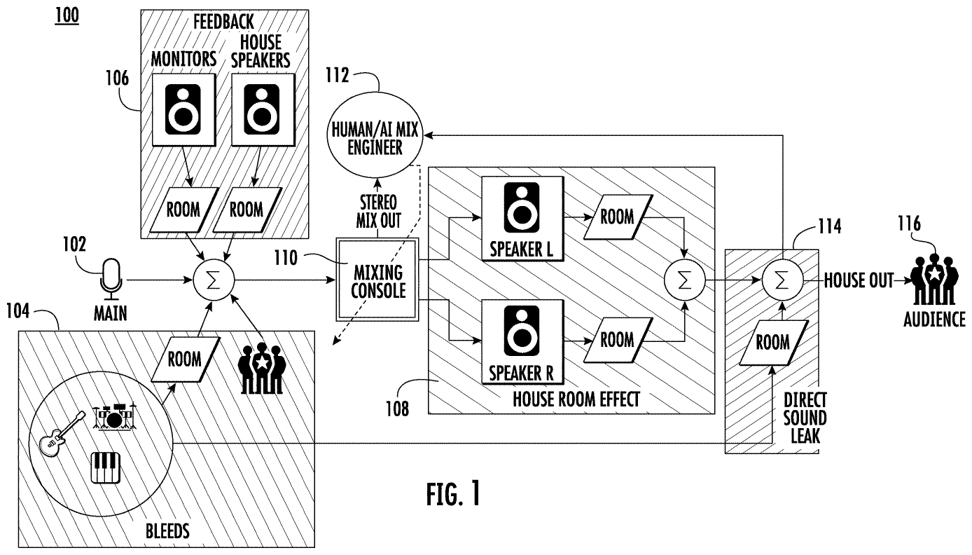

FIG. 1 depicts a block diagram of an example live performance audio mixing system 100, according to embodiments of the present disclosure. The live performance audio mixing system 100 shown in FIG. 1 illustrates various components and signal paths involved in processing and mixing audio in a live performance environment. The system live performance audio mixing 100 includes a feedback section 106 containing monitors and house speakers, with corresponding room response blocks below each speaker to model the acoustic effects of the performance space. The audio reinforcement of feedback section 106 (e.g., sound generated by speakers and/or monitors) may result in feedback when that sound is amplified by microphones or other components of the live performance audio mixing system 100.

A main input microphone (or other capture device) (e.g., or multiple capture devices or microphones, though not shown) 102 provides one or more signals along with signals from the feedback section 106 and a bleeds section 104. The bleeds section 104 may contain musical instruments such as guitars and drums, as well as additional performers, capturing audio bleed between instruments during the performance. This combined acoustic input signal is then routed to a mixing console 110.

The mixing console 110 receives the input signals and outputs a stereo mix. This stereo mix feeds into a house room effect block 108, which contains left and right speakers with associated room response processing. The house room effect processing 108 shapes the final output heard by the audience 116 through the speaker system while compensating for room acoustics.

An AI mixer (e.g., alone or in conjunction with a human engineer) 112 monitors the output and provides control parameters to the mixing console 110. The live performance audio mixing system 100 also includes a direct sound leak path 114 that accounts for acoustic sound reaching the audience 116 directly, bypassing the sound reinforcement system.

In some cases, the live performance audio mixing system 100 may adapt predicted mix parameters in real-time based on feedback from an audio capture device placed in the performance space. For example, a front of house (FOH) audio recording from a microphone placed in the audience may be used to capture information about room effects and acoustic sound levels. This feedback may allow the live performance audio mixing system 100 to make dynamic adjustments to the mix to optimize the audience experience.

In some examples, the live performance audio mixing system 100 may be configured to perform preprocessing on input channels to suppress bleeds or remove crowd noise before passing audio to the AI mixer 112. This preprocessing step may help isolate individual instrument signals and improve the overall clarity of the mix.

In some implementations, the live performance audio mixing system 100 may use image or audio analysis techniques to automatically align microphones or steer monitor and PA speaker placements. In some implementations, image analysis may be employed to compensate for a poor source to microphone relationship (e.g., EQs for off-axis sources). This automated alignment may help minimize feedback and optimize sound quality for both the performers and the audience.

The architecture of the live performance audio mixing system 100 allows for both automated AI mixing capabilities as well as human mix engineer control. By processing various audio paths including feedback 106, bleeds 104, and direct sound 114, the live performance audio mixing system 100 may generate a final mixed output tailored to the specific acoustic environment and performance requirements.

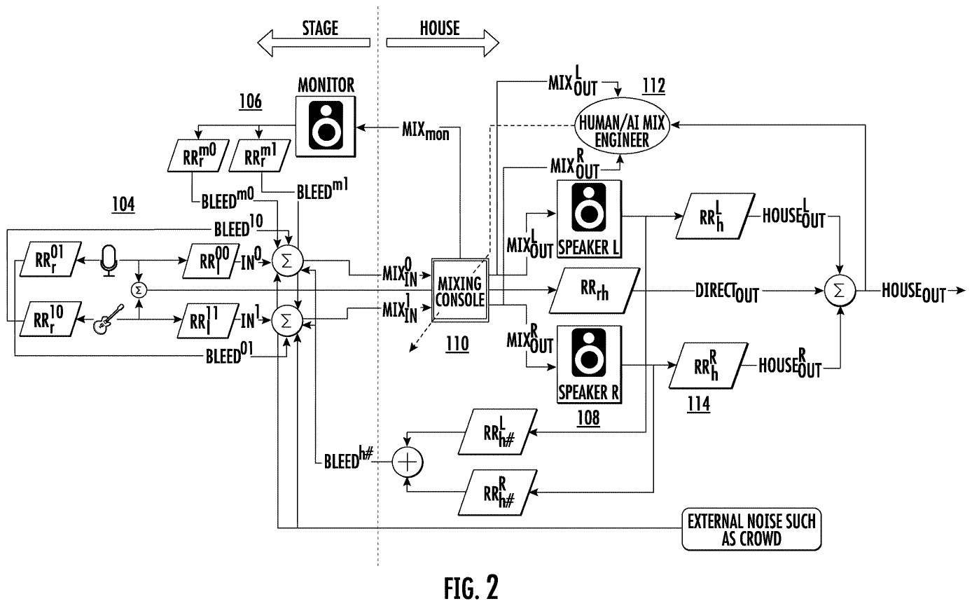

FIG. 2 illustrates another block diagram of an example live performance music mixing system. The example live performance music mixing system includes a stage side and a house side separated by a dotted line shown in FIG. 2.

On the stage side, the example live performance music mixing system includes multiple input channels for receiving audio signals, such as from microphones capturing different instruments. In some cases, these input channels may comprise multichannel data streams that include both audio and video data. The audio data may capture the sound of individual instruments or vocals, while the video data may provide visual information about the performers and their movements on stage.

The input channels may feed into monitor speakers and/or also connect to mixing controls (e.g., on a mixing console on the house side). The monitor speakers allow performers on stage to hear themselves and other instruments during the performance. The mixing controls of the mixing console may be used to adjust various parameters of the audio signals, such as volume levels, equalization, and effects.

On the house side, the mixing console may generate one or more mixed output channels of audio. For instance, the mixing console may include speaker outputs for left, right channels, and/or additional channels (not pictured). The speakers may receive the mixed channel outputs from the mixing console, and reproduce the mixed audio channels to the audience.

The mixing console may be controlled by a human and/or AI mix engineer. The human/AI mix engineer receives mix parameters and controls, and is capable of making mixing decisions based on the received parameters and controls at its disposal.

The system processes the audio through various routing and mixing stages before outputting the final house mix. Multiple feedback paths are incorporated, including direct sound reinforcement and house mix monitoring. These feedback paths allow the human/AI mix engineer to hear or process the actual sound in the performance space and make adjustments accordingly.

In some examples, external noise such as crowd sounds can be accounted for in processing the audio from the audio input channels. For instance, the system may use techniques to isolate and manage such external noise, either by suppressing the noise in order to focus on the main performance or by incorporating the noise at appropriate levels to maintain a more “live” atmosphere.

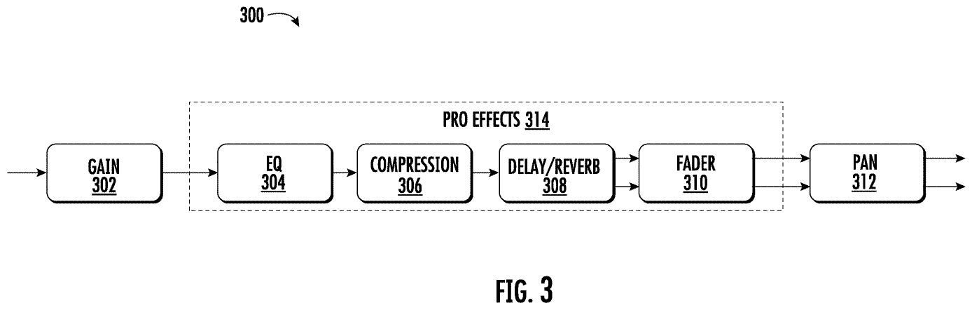

FIG. 3 illustrates a block diagram of an example instrument signal chain 300 that may be used in conventional manual mixing processes. The signal chain includes multiple audio processing stages arranged in series within a pro effects processing block 314.

In some cases, the signal chain 300 may begin with a gain stage 302. The gain stage 302 may be used to adjust the overall level of the input audio signal. Following the gain stage 302, the signal may pass through an equalization (EQ) stage 304. The EQ stage 304 may allow for adjustment of specific frequency ranges within the audio signal. After equalization 304, the signal may be routed to a compression stage 306. The compression stage 306 may be used to reduce the dynamic range of the audio signal, helping to control peaks and maintain consistent levels. Next in the chain 300 may be a delay/reverb stage 308. The delay/reverb stage 308 may add time-based effects to the signal, such as echoes or simulated room ambience. Following the delay/reverb processing 308, the signal may pass through a fader stage 310. The fader stage 310 may allow for fine control over the overall level of the processed signal. The final stage in the example signal chain 300 may be a pan stage 312. The pan stage 312 may be used to position the audio signal within the stereo field.

### Example Multi-Rate Multi-Modality, Multi Use Mixing Systems

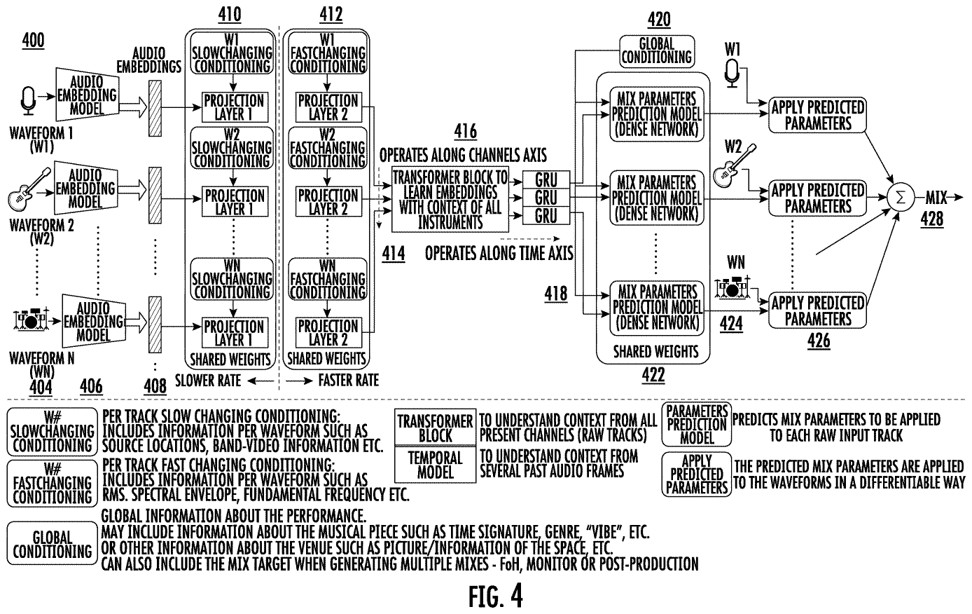

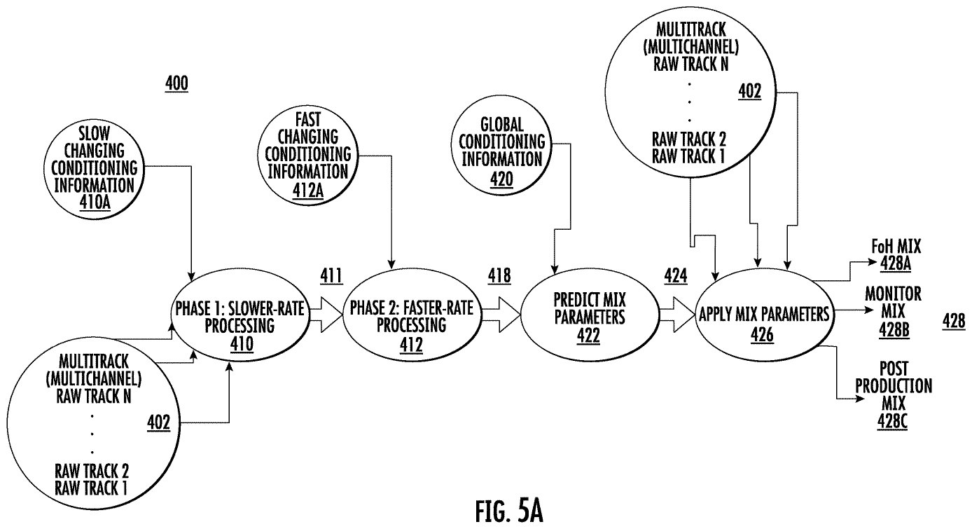

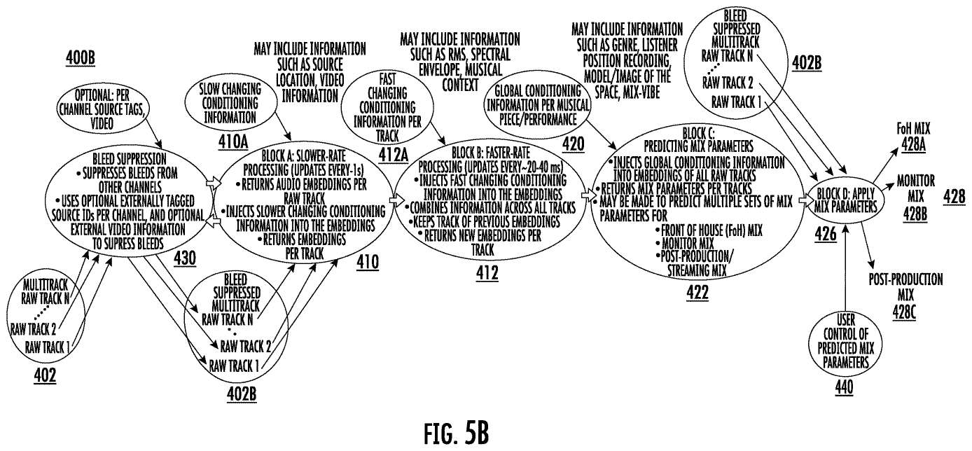

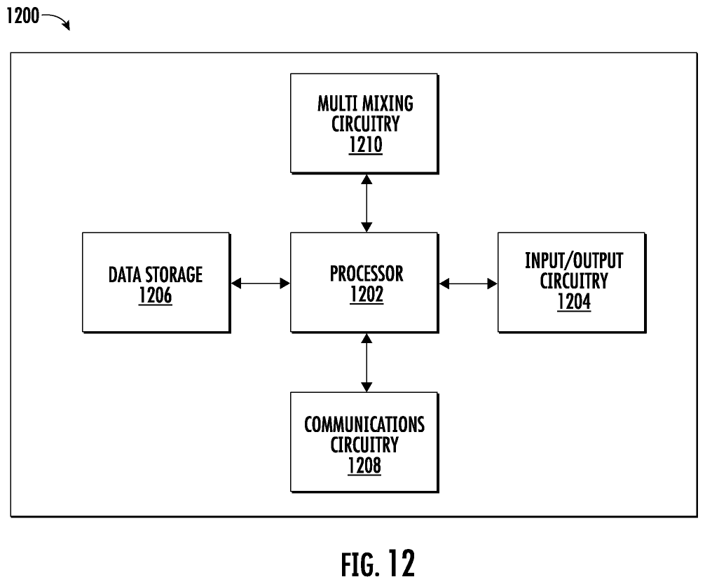

The multi-rate, multi-modality, multi-use mixing system depicted in FIGS. 4, 5A, and 5B illustrate a sophisticated architecture for processing and mixing multiple audio inputs, in accordance with embodiments of the present disclosure. Operations of the system may be provided by an example apparatus 1200 depicted in FIG. 12 and described below.

FIGS. 4 and 5A depict a multi-rate, multi-modality, multi-use mixing system 400 that may receive multiple waveform inputs (e.g., a multichannel data stream) 404, labeled W1 through WN, where each waveform may represent an audio channel or track 402 (see, e.g., FIG. 5A) and have been captured using one or more capture devices. It will be appreciated that one or more of the waveform inputs may be multi-modality (e.g., audio, video, or other non-audio sensor information). A multichannel data stream may comprise a set of related audio, video, or other non-audio sensor signals that are processed together. In some cases, a multichannel data stream 402/404 may comprise multiple audio tracks recorded simultaneously during a performance, such as individual instrument or vocal tracks. In other cases, a multichannel data stream may include both audio and video data captured from multiple sources. The data within a multichannel stream may be temporally aligned and may share common characteristics or context.

The one or more capture devices may correspond to one or more microphones, such as: condenser microphones, micro-electromechanical systems (MEMS) microphones, dynamic microphones, piezoelectric microphones, one or more microphone arrays, one or more beamformed lobes of a microphone array, one or more linear microphone arrays, one or more ceiling microphone arrays, one or more table microphone arrays, one or more virtual microphones, one or more network microphones, one or more ribbon microphones, or another type of microphone configured to capture audio. It is to be appreciated that, in some examples, the one or more capture devices may additionally or alternatively include one or more video capture devices, one or more infrared capture devices, ultrawideband devices, one or more sensor devices, and/or one or more other types of capture devices.

Each waveform input (e.g., or channel data stream) may be processed through an embedding model 406 to generate audio embeddings 408. An embedding model may be a neural network or other machine learning model designed to convert input data into a compact representation. In the context of audio processing, an embedding model may take raw audio waveforms or spectrograms as input and generate embeddings that capture relevant features of the audio signal. These embeddings may encode information about the audio content, such as instrument type (e.g., guitar, vocals, drums, etc.), tonal characteristics, or rhythmic patterns. In the case of bleeds, the embedding may represent multiple instrument types that are detected as having bled together. In some cases, the embedding model may be pre-trained on a large dataset of audio samples and fine-tuned for specific mixing tasks. In some cases, the audio embedding model may comprise a convolutional neural network designed to extract relevant features from the input audio signals.

The multi-rate, multi-modality, multi-use mixing system 400 may employ parallel processing paths to handle features that change at different rates. A first path 410, denoted as “SlowChanging” in FIG. 4, may process slowly changing features 410A, while a second path 412 may handle rapidly changing features 412A. This multi-rate approach may allow the system to efficiently capture both long-term and short-term characteristics of the audio signals.

In the first path 410, the embeddings may be combined with slow-changing conditioning information 410A and processed through a projection layer to generate new embeddings. The slow-changing conditioning information 410A may include features such as source identification or location information (e.g., from trackers worn by one or more performers or obtained from video information). The slow-changing conditioning features may be associated with a first modification rate or rate at which the data or features change.

In some examples, the audio embedding model 406 for each channel 402/404 may be a relatively large model. In such cases, computational cost may be minimized by only running the audio embedding model once during sound check to obtain one audio embedding per channel and using these obtained embeddings to define the channel for the rest of the performance. However, computing the embedding model upfront may limit the system from: allowing changes of instruments mid-performance, or changing a guitar patch, as examples. However, computing the embedding during soundcheck might be useful in low-key performance settings that lack mid-performance patch changes. In some examples, the system may register multiple audio embeddings per channel during sound check and the embeddings may be switched every time there is a patch change. In some examples, the embedding model may be adapted to the specific music mixing use-case thus allowing the embedding model to also embed additional relevant information such as “amount of bleed” from co-located musicians. To embed the extents of bleed, during training bleeds may be injected into clean raw tracks by calculating the transfer functions between all source and microphones and randomizing the placements of the sources and their microphones. Some instruments may also be randomized to be “Direct Injection (DI)”, thereby ensuring that the embeddings have seen that scenario. The Direct Injecting of instruments may be randomized using a probability table containing the instrument types and their probabilities to be used as a DI in a live performance.

When applying this system in a live music performance, the inputs fed to the embedding model 406 may first undergo some “high-fidelity clean-up preprocessing” to suppress bleeds, or crowd cancelling, or feedback removal. Conditioning information or data may include musical contextual information such as the fundamental frequency, tonal or percussive tag, lead or backing tag, etc. A human mix engineer subconsciously uses this information when determining the appropriate mix parameters and thus embodiments of the present disclosure also benefit from knowing such information. Conditioning information may be obtained through a combination of computation and user provided inputs. For example, the fundamental frequency may be computed on a frame-by-frame basis as part of the “FastChanging” information, while the tonal or percussive tag, or lead or backing tag might be user-provided and can be a part of the “SlowChanging” conditioning, or even be a part of the “global” conditioning. Such information further enables the system to learn patterns which provide additional information. For example, knowing the fundamental frequency helps the system make a prediction about whether the track is lead or backing, without the user having to provide that information.

Conditioning information may also include information about source and pickup locations. This information may be made available using tracking devices worn by the performers as well as attached to the pickup devices. This provides the system with context to interpret how much each channel would bleed into each other, better informing the system to accurately predict the mix parameters. Trackers worn by the performers may also be used to make panning decisions. Alternatively, locations may also be extracted from a video of the performance using object tracking. This type of information may become a part of the “SlowChanging” conditioning information.

Conditioning information may also include Front of House (FOH) audio recording information. A microphone placed in the audience records the audio it receives, which contains useful information about the environment such as the room effects (the reverberation caused by the room) and about the natural acoustic sound level of the instruments which travels to the audience in addition to the amplified signal generated by the PA system. This information may be used to predict mix parameters that account for the room effects and for the acoustic sound levels of instruments, to control the extent of sound reinforcement to apply to every instrument in the mix. For example, some loud instruments such as drums (particularly in a small space) may require little to no amplification due to their loud acoustic sound. The FOH microphone may capture the information about the loudness of the acoustic instruments and then feed that to the system allowing the system to adapt accordingly. The FOH microphone may also be used during sound check to measure the impulse response of the room to provide as conditioning information to the system to compensate for it. The FOH microphone may also be able to capture “noises” in the environment-claps, cheering, whistling etc. This information may be useful for algorithms used to cancel out these noises from the mix if the application desires it.

The second path 412 may combine the new embeddings 411 with the fast-changing conditioning information 412A and process them through another projection layer. Fast-changing features 412A may include characteristics like RMS levels or spectral envelopes (e.g., to distinguish instruments from each other, for instance, based on differing timbres). These fast-changing features 412A may be calculated on a frame-by-frame basis from the input audio signal. The fast-changing features 412A may be associated with a second modification rate or rate at which the data or features change, and the second modification rate may be faster than the first modification rate. In some cases, the second modification rate may be approximately every 20 to 40 milliseconds (or up to 100 milliseconds, for example). The output of the second path 412 may include per-channel embeddings 414—that is, the output of the second path includes an embedding specific to each channel or track that has accounted for both slow-changing features and fast-changing features.

Inter-channel contextual embeddings 418 may be generated by inputting the per-channel embeddings 414 to a contextual embedding model 416. This model 416 may learn interactions among the per-channel embeddings 414, effectively capturing relationships between different multichannel data streams. A contextual embedding model 416 may be a neural network component designed to capture relationships and interactions between different input channels or streams. This contextual embedding model 416 may take as input the per-channel embeddings 414 generated by earlier stages of the system and produce new embeddings 418 that incorporate contextual information from all channels. In some cases, the contextual embedding model may be implemented using a transformer architecture, which can effectively model complex dependencies between different inputs. The resulting inter-channel contextual embeddings 414 may capture information about how different audio sources interact and influence each other within the mix. The contextual embedding model 416 may comprise both a transformer model (or transformer block) to capture complex dependencies and a temporal model to incorporate long-term dependencies between different streams. The transformer block may learn embeddings with context of all instruments, operating along the channels axis. The transformer architecture may allow the system to capture complex dependencies and interactions between different audio channels. The learned interactions may be relationships between channels that are discovered by the neural network during training, such as correlations between instrument types, relative levels, or temporal patterns.

Following the transformer block, the multi-rate, multi-modality, multi-use mixing system 400 may employ an RNN (recurrent neural network) that operates along the time axis. In some embodiments, examples of the RNN may be GRU (gated recurrent unit) layers, a long short-term memory (LSTM) network, or a transformer. The RNN may help incorporate temporal context and short-term and long-term dependencies into the audio processing, and may indicate how mix parameters depend on each input channel independently, as well as how the channels interact with each other. The short-term and long-term dependencies may refer to relationships between audio features that span multiple processing frames, such as musical phrases, rhythmic patterns, gradual changes in dynamics, timbres and other relevant musical/audio features relevant to the task.

Next, the multi-rate, multi-modality, multi-use mixing system 400 feeds the inter-channel contextual embeddings 418 along with global conditioning data 420 into a mix parameter prediction network 422 to generate a set of predicted mix parameters 424 for each of a plurality of different mix types. A mix parameter prediction network 422 may be a neural network component responsible for generating the final mixing parameters based on the processed embeddings and additional conditioning information. This mix parameter prediction network 422 may take as input the inter-channel contextual embeddings 418 and global conditioning data/information 420, and output a set of predicted mix parameters 424 for each input channel. The mix parameter prediction network 422 may be implemented using one or more dense layers with shared weights across channels, allowing it to generate consistent mixing decisions for all inputs while still accounting for their individual characteristics and context.

Global conditioning data/information 420 may refer to high-level information about the overall context of the audio or video content being processed. This may include multichannel stream independent data such as the time signature or genre of a musical piece, information about the performance venue, or reference audio signals captured at listener positions. Global conditioning data/information 420 may also include multichannel stream dependent information, such as tags identifying lead or backup instruments, or indicators of tonal or percussive content. By incorporating this global context, the mixing system 400 may make more informed decisions that account for the broader structure and intent of the content.

In some embodiments, the inter-channel contextual embeddings 418 are concatenated with the global conditioning parameters 420 before being passed through the mix parameter prediction network 422 that predicts the mix parameters 424. The global conditioning parameters 420 may include generic information about the performance which is either track-independent or track-dependent, but does not change over time. Track-independent information may include items such as the time-signature of the musical piece, genre of the piece, information about the venue of performance such as a model of the space, or a picture of the space, or a reference audio signal recorded at the listener position etc. Track-dependent information may include items such as a tag for lead vs. backing, tonal vs. percussive tag, etc. Some of the global conditioning information 420 may be fed to the system as user-input, while some of the information might require further processing after user-input (e.g., an image of the venue might go through image processing step(s) to extract relevant features).

The reference audio signal 402 recorded at the listener position may be directly made available to the system without user involvement; this may require further preprocessing to extract relevant features before being made available as global conditioning information. Some global conditioning information may also be input using vocal commands (e.g., the user may describe the “vibe” of the mix in layman terms such as “tinny”, “crisp”, etc.). This input information may then be fed through an LLM to obtain the necessary language embeddings which may then be used as global conditioning information. An additional global conditioning parameter (or set of parameters) may also be the mix-target for the system to generate one of 3 (or more) target mixes by applying the appropriate conditioning tag.

The predicted mix parameters 424 may then be applied 426 to the original waveforms or channel data streams 402. The processed waveforms may be summed to create the final mixed output stream 428. The system may be capable of generating multiple types of output mixes simultaneously. For example, the system may produce a front of house (FOH) mix 428A for live sound reinforcement, a monitor mix 428B for performers on stage, and a post-production mix 428C for recording or broadcast purposes. Examples of predicted mix parameters include gain, pan, EQ parameters, compression parameters, delay parameters, reverb parameters, a mask, etc. A mask may be a predicted mask, which may comprise a set of values that selectively attenuate or emphasize portions of an audio signal, such as a time-frequency mask applied to a spectrogram representation.

It will be appreciated that embodiments herein are applicable to mixing video as well as audio. For example, each video capture device (e.g., camera) may have one or more frames in sequence passed through embedding models, then through contextual embedding models to determine inter-channel contextual embeddings, which can then be used to predict a plurality of video mix parameters. Examples of video mix parameters may include, without limitation, the right camera(s) to mix, steering a PTZ camera(s) or virtual frame(s) in the right sub-view of a camera(s), optimal motion effects, and/or rendering frames into the right composited stream(s). It will also be appreciated that audio and/or video mixing applications of the present disclosure may be employed for local consumption and/or streaming to remote audiences and content services, etc.

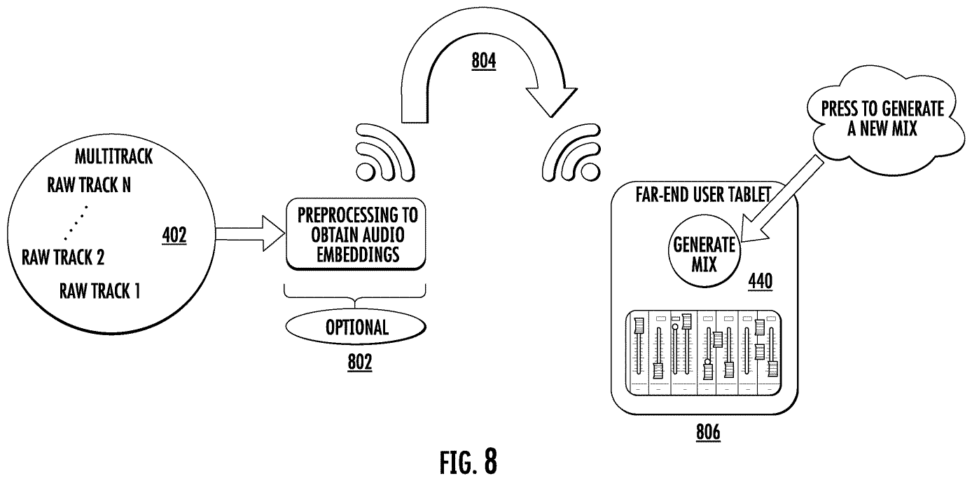

In some cases, the system may generate a user interface 440 for controlling (see, e.g., FIGS. 5B, 8) the mixed output stream. This user interface may be transmitted to a remote device, allowing users to adjust mix parameters or select different mix options from a separate location. The system may also be designed to receive user input and adjust the predicted mix parameters based on that input. This user input may be received via interactions with the user interface. This feature may allow for a balance between automated mixing and human creative control.

In some implementations, the system may leverage observed mix statistics correlated to audio embeddings to produce a variety of mixes that fall under generally acceptable mix categories. This approach may allow the system to generate multiple mix options that adhere to common mixing practices while still providing variety and flexibility.

FIG. 5B depicts another embodiment of system 400, shown as system 400B, which includes bleed suppression 430 to the multichannel data streams 402 prior to the parallel processing paths, and applying the predicted mix parameters to bleed suppressed multichannel data streams 402B. Bleed suppression 430 suppresses bleeds from other channels and uses optional externally tagged source identifiers per channel and optional external video information to suppress the bleeds.

Predicting mix parameters in the presence of bleeds becomes especially challenging in scenarios when there are some inactive channels (channels where the primary instrument is not making any sound but receives bleeds from other instruments that are playing currently). One reason for this challenge is that all of the inactive channels will produce similar audio embeddings representing the bleeds of the currently active instruments they receive.

For example, there are 4 channels in the performance (e.g., guitar, vocals, bass and keys), and the song begins with only the vocals and the guitar playing. In this scenario, because the bass and the keys are not currently playing, the bass and keys channels would both only comprise of bleeds they receive from the vocals and guitars. Thus, the signals that the bass and keys channels are receiving would likely produce similar audio embeddings signifying that those channels contain vocals and guitar. When predicting mix parameters in this scenario, a model may not have any information informing it that it needs to ignore the bass and keys channels and only consider the vocals and guitar channels when predicting the mix parameters. Thus, the model likely gets confused and tries to use the bleed-only channels to achieve the mix which is not desirable.

To address such challenges, embodiments herein may tag and/or register every channel to its desired instrument via one or more techniques. A first technique may involve tagging or registering each channel with its desired audio embedding. This may be achieved by running an audio embedding model on every channel during sound check, either through playing each instrument one at a time, or by asking all musicians to play simultaneously.

A second technique may involve receiving user input regarding desired instruments from a list of instruments. Upon user-entry, this information can be directly used as conditioning information, or the audio-embeddings for the selected instrument may be fetched from a repository of saved audio embeddings. The audio embeddings registered to every channel may then be used to inform the model about which channels are currently active and which are not.

A distance between the embeddings generated by the model during the music performance and the “tagged” audio embeddings obtained during soundcheck may be computed. If the two embeddings are far apart (e.g., exceeding a distance threshold), the model may infer that the signal it is currently receiving is bleed-only. Once a channel is detected to be in bleed-only mode, the embeddings of that channel during that section may be replaced with embeddings representing “silence.” Alternatively, the audio being received in these sections may be replaced with silence, thus achieving a full bleed suppression. This then forces the model to only use the information from the currently active channels to produce the mix parameters.

The aforementioned challenges may be more intense at the beginning of a music performance when the model has no information about the future of channels that have not yet become active. On the contrary, if a channel becomes inactive in the middle of a performance after the model has already seen what the channel is supposed to be, the model is better able to use its historic information of when the channel was active, to make better decisions. Thus, as a second option, instead of post processing the embeddings to be replaced with embeddings representing silence, the “tagged” audio embeddings (or user-input instrument info) may be fed as additional conditioning information to the mixing system of embodiments herein. This conditioning information informs the model of the audio embeddings it is supposed to be receiving and thus when it receives a different audio-embedding during the times when the instrument belonging to that channel is not playing, the model self-learns how to handle such a scenario.

Scenarios herein may describe pre-tagging every channel with a desired instrument. However, in certain scenarios, the performer may want to switch the instrument they are playing on a particular channel in the middle of a performance. This type of situation may be addressed with embodiments herein using a variety of techniques. For example, during soundcheck, a performer may register every channel with multiple instruments, and the “tagged” audio embeddings of each of these instruments would then be used when determining whether the channel is active or not. By way of further example, a “switch” or selection button may be provided to the performer which the performer is expected to press each time they expect an instrument/patch change. Each time the “switch” button is pressed, the “tagged” audio embeddings are recomputed and the channel will then be registered with this new audio embedding. By way of further example, the “tagged” audio embeddings for every channel may be periodically updated based on certain criteria. The criteria may be defined using information such as comparing the audio embeddings with its tagged embeddings, comparing the audio embeddings of all channels with each other, comparing the signal levels of each channel.

For a particular channel, if the received audio embedding matches its tagged audio embedding, that would mean the “tagged” audio embedding is valid and the channel is currently active. If the “tagged” audio embedding does not match the received audio embeddings, it may mean either that the channel is inactive, or that the instrument has switched and the “tagged” audio embedding now needs updating. To determine which of the above is true, embodiments herein consider factors such as the loudness of the signal being received and comparisons of its audio embedding with the audio embeddings of the other channels. Alternatively, the received embeddings of every channel can be compared with the “tagged” embeddings of every other channel. If the receiving audio embedding is a new instrument, its audio embedding will not match the audio embeddings of any “tagged” audio embeddings and that would indicate that the received audio embedding would need to be registered as the “new” “tagged” audio embedding for that channel.

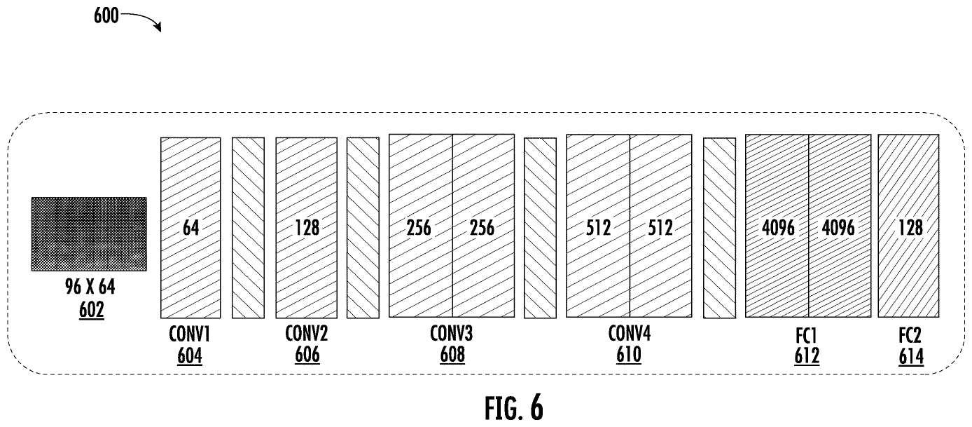

FIG. 6 depicts an example embedding model (e.g., audio embedding model) 600 for use with embodiments of the present disclosure. The embedding model architecture 600 illustrated in FIG. 6 may be used to process audio inputs and generate embeddings for use in the multi-rate, multi-modality, multi-use mixing system. In some cases, the embedding model 600 may comprise a convolutional neural network designed to extract relevant features from input audio signals.

The input to the embedding model may be a mel spectrogram representation 602 having dimensions of 96×64. Mel spectrograms may provide a compact representation of audio signals that emphasizes perceptually relevant frequency content. The architecture may contain multiple processing stages arranged in a sequential flow. In some cases, the model may include convolutional layers, max pooling layers, and fully-connected layers.

The network may begin with a first convolutional layer (conv1) 604 with 64 filters. This layer may be followed by a max pooling layer, which may reduce the spatial dimensions of the feature maps while retaining important information. A second convolutional layer (conv2) 606 with 128 filters may follow, succeeded by another max pooling layer. This progressive increase in the number of filters may allow the network to capture increasingly complex audio features. The third stage may contain two parallel convolutional layers (conv3) 608, each with 256 filters. These parallel layers may be followed by a max pooling layer. Similarly, the fourth stage may have two parallel convolutional layers (conv4) 610, each with 512 filters, followed by a max pooling layer.

The final portion of the network may consist of fully-connected layers. In some cases, the first fully-connected layer (fc1) 612 may contain two parallel sections, each with 4096 neurons. The second fully-connected layer (fc2) 614 may contain 128 neurons. The convolutional layers may apply filters to the input or previous layer's output to detect local patterns and features in the mel spectrogram. The max pooling layers may help to reduce the spatial dimensions of the feature maps, providing some translation invariance and reducing the computational load.

The fully-connected layers at the end of the network may integrate information from across the entire input, potentially capturing global patterns and relationships in the audio signal. In some cases, the embedding model may process the input mel spectrogram through multiple stages of convolution and pooling before final processing through fully-connected layers. The network may progressively increase the number of filters in deeper convolutional layers while reducing spatial dimensions through pooling operations.

The output of this embedding model may be a compact representation of the input audio signal, capturing relevant features that can be used in subsequent stages of the mixing system. These embeddings may encode information about the audio content, such as instrument type, tonal characteristics, or rhythmic patterns.

It will be appreciated that the embedding model may be used in several ways in accordance with embodiments herein. For example, the embedding model may comprise a pretrained model that is configured for source identification. The embedding model may use a particular model structure but be trained using datasets related to an audio mixer or system of embodiments herein. The embedding model may be jointly trained with the remainder of the mixing/mixer system of embodiments herein. The embedding model may be trained in a staggered fashion (e.g., some embedded training by itself, then transfer learned to training jointly with the rest of the mixer system of embodiments herein).

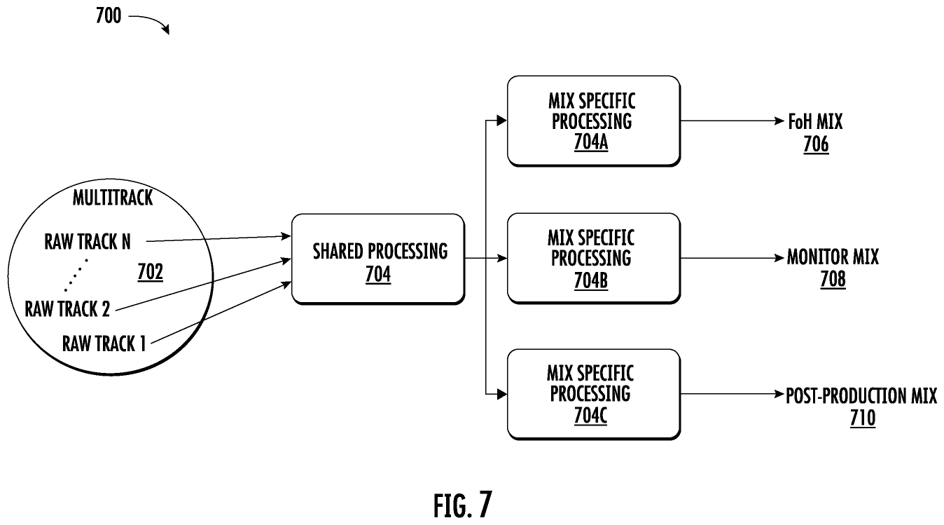

FIG. 7 depicts a block diagram of example multi-use mixing 700 for use with embodiments of the present disclosure. In some embodiments, N channels 702 of audio and/or video (e.g., possibly wireless; also other non-audio or non-video sensor data) are received as input for processing (704, 704A, 704B, 704C) such that multiple versions of mixes are simultaneously generated and output. Examples of versions of mixes include, without limitation: Front of House sound reinforcement 706, monitor/PSM mixes 708 for musicians, or production recording output 710 for archival or streaming.

Typically, a live performance requires multiple mixes to be generated simultaneously. For example, one mix for front of house consumption (which includes compensation for the room effects), one mix for post-production or streaming consumption (which does not compensate for the room effects), one or several monitor mix(es), where different instruments are in focus, may all be desired simultaneously. A spatial mix may also be generated, which may comprise an audio output formatted for spatial audio playback systems which position sound sources in three-dimensional space. Much of the information about the input channels is common when generating these mixes (e.g., the audio embeddings that embed the instrument information may remain the same regardless of the desired mix). Resources are conserved if, instead of using independent systems to generate each of the desired mixes, the same system (according to embodiments herein) is used to generate multiple mixes simultaneously, or using a user-input, by training the system with each of the desired ground truth mixes. This way the model shares information that is common between all mixes and will diverge for information that is different for every mix as shown in FIG. 7. Multiple monitor mixes can be generated with knowledge of spatial positioning of the musicians to balance the monitoring needs across the stage.

FIG. 8 illustrates a block diagram of an example generative AI mixing user workflow for use with embodiments of the present disclosure. The system may receive a multitrack input containing multiple raw audio tracks 402. In some cases, these raw audio tracks may comprise multichannel data streams. The multitrack input may be provided to an optional preprocessing block 802. This preprocessing block may obtain audio embeddings from the raw tracks. In some cases, the preprocessing may involve inputting each multichannel data stream to an embedding model to generate one or more respective embeddings.

The preprocessed audio data may be transmitted wirelessly 804 between components, which may allow for flexible placement and operation of the mixing interface separate from the audio input sources. The system may include a far-end user tablet device 806 that receives the transmitted audio data. The tablet device may contain a generate mix interface 440 with mixing controls displayed to the user. For example, a “Press to generate a new mix” prompt may be shown in a dialog bubble above the tablet interface.

In some cases, the system may generate mix parameters in a probabilistic manner. This approach may involve sampling from a parametric probability distribution to produce slightly different but valid mixes each time the user interacts with the user interface 440. By allowing for variation in the generated mixes, users may explore different mixing options without requiring detailed technical knowledge of mixing parameters.

The user interface 440 may provide an intuitive way for users to generate and control mixes. In some cases, the system may use speech commands and natural language processing to adjust mix parameters based on user voice input. For example, a user may provide voice commands such as “add more reverb to the vocals” or “increase the guitar level,” and the system may interpret these commands to adjust the corresponding mix parameters.

The generate mix interface 440 may allow users to trigger the generation of new mixes through the interface controls. When activated, the system may generate a plurality of predicted mix parameters by inputting the processed audio data and any additional conditioning information to a mix parameter prediction network.

In some cases, the system may apply the plurality of predicted mix parameters to the plurality of multichannel data streams to generate a mixed output stream. This mixed output stream may then be played back through the tablet device or transmitted to other playback systems.

The wireless connectivity and user interface may allow for remote operation of the mixing system. Users may be able to move around a performance space while still maintaining control over the mixing process. This flexibility may be particularly useful in live performance scenarios where the mix engineer needs to assess the sound from different locations in the venue.

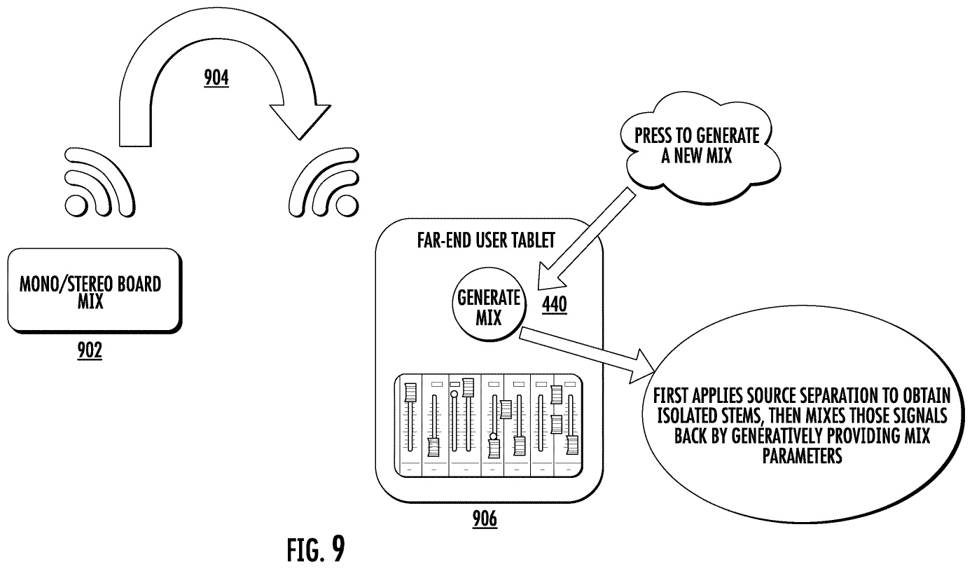

FIG. 9 illustrates a block diagram of an example generative AI mixer using source separation for use with embodiments of the present disclosure. The system may receive a mono/stereo board mix as input. This input mix may be processed through wireless transmission to a far-end user tablet.

The far-end user tablet may include a generate mix interface with a button that allows users to generate a new mix. When activated, the system may first apply source separation to the input mix 902 to obtain a plurality of isolated stems. Source separation techniques may be used to decompose the mono or stereo input into individual instrument or vocal tracks. In some embodiments, neural network-based source separation is utilized.

After obtaining the isolated stems, the system may remix those signals back together by generatively providing mix parameters. The mixing process may involve analyzing the separated stems and determining appropriate mix parameters to create a balanced output. In some cases, the system may generate a plurality of predicted mix parameters by inputting the isolated stems and any additional conditioning information to a mix parameter prediction network.

The system may enable users to generate different variations of mixes from the same input by pressing the generate mix button multiple times. Each time the button is pressed, the system may apply the plurality of predicted mix parameters to the isolated stems to generate a new mixed output stream. This approach may allow users to explore different mixing options without requiring detailed technical knowledge of mixing parameters.

The user interface 440 may provide an intuitive way for users to generate and control mixes. In some cases, the system may generate a user interface 440 for controlling the mixed output stream and transmit 904 the user interface 440 to a remote device 906. This may allow users to adjust mix parameters or select different mix options from a separate location.

The wireless transmission 904 between components may allow the system to operate remotely while maintaining audio quality. This flexibility may be particularly useful in live performance scenarios where the mix engineer needs to assess the sound from different locations in the venue. This flexibility may also be useful for musicians to generate their own monitor mixes.

For example, a human mix engineer may wish to finetune/override the mix parameters generated by the system. To enable this, the system may return a combination of absolute as well as relative parameters (relative to the previous absolute setting, for example, dB gain with respect to the previous absolute gain setting). The absolute predictions may be used to set the system up initially and also update at a very slow rate when in need of re-calibration (e.g., serving as slow-moving balancing). The relative predictions may update at the fastest rate where the predicted parameters are relative to the previously computed absolute parameters (e.g., this prediction denotes by what level to adjust the levels of the channel with respect to its previous level). Having these absolute and relative predictions happen parallelly then allows the user to seamlessly interject and finetune the mix parameters such that each time the user updates the predicted parameters, it re-calibrates the system to a new absolute setting, and successive adjustments then happen using the relative predictions. In the case of the processing taking place on a mobile device, the user may finetune the parameters both on the mobile device as well as on the hardware device.

By way of further example, when a user interjects the system to update the mix parameters, the system may note a difference between the mix parameters suggested by the system and what the user selects. This difference may then be applied to all successive system predictions.

By combining source separation techniques with generative mixing capabilities, the system may create new mixes while preserving the core musical elements from the original input. This approach may provide a powerful tool for exploring creative mixing options, especially in situations where access to individual multitrack recordings is not available. Some embodiments may leverage video analysis to determine a taste of mixing according to embodiments herein based on a musician composition or venue, for example. This functionality is beneficial when multiple bands are playing at a venue. In such scenarios, a band may register their preferred mix after soundcheck along with their video. When it comes time for the band to perform, the mixer of the present disclosure automatically adapts to the band's preferred setting(s). Video analysis may further or alternatively be leveraged to determine that a musician is “stepping up the to the microphone” to turn a particular channel to a safe level that would allow the instrument through before they begin playing so that it is audible until the mixing system of the present disclosure can apply the correct gain for the appropriate mix (methods for keeping latencies down).

Some embodiments may be configured to predict pan parameters. In the case of predicting gains for a stereo mix, it might not be practical to request that the system make absolute pan decisions. This is because in a mix, a more important factor may be the relative stereo width of the mix as opposed to the absolute decisions. For example, it may matter less whether the guitar is panned to the left or the right, and matter more how far to the left or right from center the guitar is panned. To address these challenges, embodiments herein may predict a “relative pan” parameter instead. The “absolute” pan parameter (which then takes the relative pan value and controls the track's absolute placement in the left vs. the right channel) can then be determined using different techniques.

A first technique may involve using external multi-modal information such as a video of the band to determine the performer location and assigning absolute pan values accordingly. For example, if the guitarist is standing to the right, the guitar channel is placed in the right channel using the “relative” pan value to set the stereo width. A second technique may involve using heuristics (e.g., a snare always goes on the left, etc.). A third technique may involve running an optimization routine (perhaps during sound check) to assign the absolute pan that results in the most balanced stereo width. This may be achieved using the relative pan values predicted by the system to try different combinations of absolute pan for every raw input channel, computing the energies of the resultant left and right channels of the mix output, and selecting a combination where the energy of the left and right channels is closest. The absolute pan may be set for every instrument channel based on this process and for the rest of the performance the relative pan predictions computed in real-time will be used to make fine adjustments. A combination of these techniques may be employed as well.

In some embodiments, the statistics gathered for generative mixing may be leveraged to create a lower complexity version of the present mixing system by using one or more of a source identifier per channel and related statistical gains to the source identifier. The statistics of the ground truths or the inferred outputs are collected, both on individual track bases and on tracks compared to the composition of all simultaneous tracks, based on the class of signal present. The RMS statistics (e.g., mean, STD, variance, etc.) of each track class is stored in a lookup matrix. Matrix dimensions both for individual tracks RMS statistics, and RMS statistics variations when other tracks are present, are stored for algorithm deployment. A source ID algorithm is run on each track. The identified sources (and the relationship of the simultaneous identified sources) are used as a lookup index in the matrix that produces the desired RMS statistics. The RMS of the input is calculated in real-time fashion and a slow moving average gain factor is calculated that, once applied to the track, creates an output track RMS that falls inside of the desired statistic.

### Example Embodiments With Zero Latency Processing

In some embodiments, the system may be configured to achieve zero latency processing by implementing a predictive approach where mix parameters are applied with temporal offset. The system may train a neural network to predict future mix parameters, allowing the application of predicted parameters to current audio frames. This approach may enable real-time mixing without perceptible delay between input and output. That is, the model is trained to predict the proper gain parameters for a next frame (e.g., the ground truth is for the next frame) even though the model may only see the current frame of audio. For the actual application, the gains for the current frame of audio may be calculated only using knowledge of the past audio.

The zero latency processing may be achieved by applying predicted mix parameters from a previous time frame to a current audio frame. In some cases, the system may predict mix parameters for a frame that is one processing interval ahead of the current frame being processed. This temporal offset may allow the system to maintain synchronization between audio and visual elements in live performance scenarios.

The multi-rate processing architecture may support zero latency operation by reducing the prediction horizon required for future parameter estimation. In some implementations, the system may only need to predict mix parameters approximately 50 milliseconds into the future when using multi-rate processing, compared to longer prediction horizons that may be required without such processing. This reduced prediction requirement may improve the accuracy of future parameter estimation.

The system may employ specialized training techniques to enable accurate future prediction of mix parameters. During training, the neural network may be configured to learn temporal patterns and dependencies that allow for reliable prediction of mixing requirements based on current and historical audio content. The training process may involve presenting the network with audio sequences where the target mix parameters are temporally shifted relative to the input audio.

In some cases, the system may incorporate temporal context modeling through recurrent neural network components that maintain information about previous audio frames. These components may help the system understand the temporal evolution of the audio content and make more informed predictions about future mixing requirements.

The zero latency processing capability may be particularly beneficial in live performance environments where maintaining synchronization between audio and visual elements is important. The system may process audio in real-time while ensuring that the mixed output remains synchronized with the live performance, avoiding delays that could disrupt the audience experience or performer coordination.

Some embodiments may implement various bleed suppression techniques. The system may use parametric tools to simulate acoustic bleeds during training, allowing the neural network to learn how to handle cross-contamination between instrument channels that commonly occurs when performers are co-located. The bleed simulation may account for factors such as room dimensions, reverberation characteristics, performer positions, microphone orientation, distance from source, and relative acoustic levels of different instruments.

The system may employ data augmentation strategies that artificially introduce bleeds into isolated instrument tracks during training. This approach may allow the system to learn from a broader range of bleed scenarios than would be available from naturally occurring bleed recordings. The data augmentation may involve randomizing parameters such as room acoustics, performer positions, microphone orientation, distance from source, and instrument levels to create diverse training scenarios.

In some implementations, the system may use the same ground truth mix targets for both isolated and bleed-augmented versions of training tracks. This approach may allow the system to learn how to achieve consistent mixing results regardless of the presence or absence of acoustic bleeds in the input channels.

The system may incorporate fine-tuning of pre-trained audio embedding models to better handle bleed scenarios. The fine-tuning process may teach the embedding model to encode information about the relative amounts of different instruments present in each channel, which may be useful for making appropriate mixing decisions in the presence of bleeds.

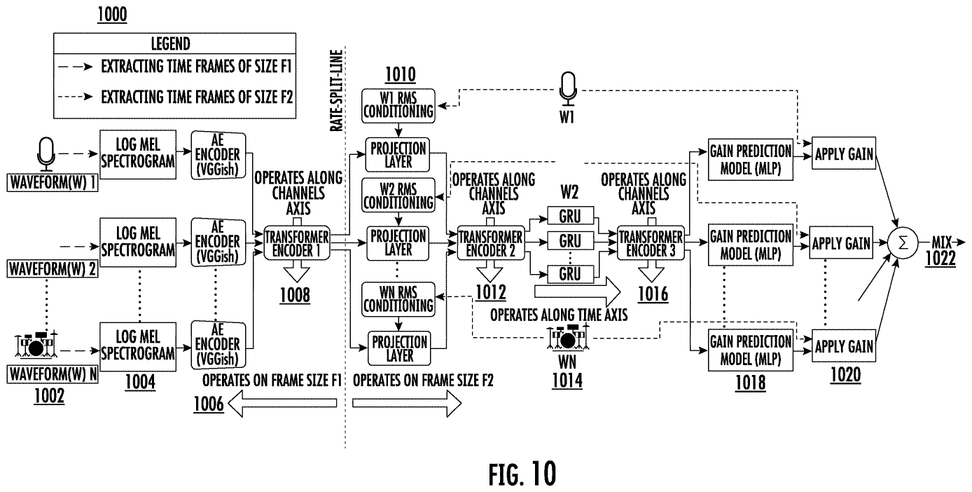

FIG. 10 illustrates a block diagram of an example multi-rate, multi-modality, multi-use processing system 1000, according to embodiments of the present disclosure. The system 1000 may receive multiple waveform inputs 1002, labeled W1 through WN, where each waveform may represent an audio channel or track that has been captured using one or more capture devices. Each waveform input may be processed through a log mel spectrogram conversion 1004 before being input to an embedding model 1006.

The system 1000 may employ a multi-rate processing architecture that splits processing into two different rates, as indicated by the rate-split-line shown in FIG. 10. Blocks to the left of the rate-split-line may operate with a frame size of F1, which may be approximately 975 milliseconds. Blocks to the right of the rate-split-line may operate with a frame size of F 2, which may be approximately 50 milliseconds or another suitable duration.

Each waveform input 1002 may be converted 1004 to a log mel spectrogram representation and processed through an audio embedding model 1006, such as a VGGish architecture. The VGGish model may comprise a convolutional neural network that generates embeddings containing information about instrument type and other audio characteristics. In some cases, the VGGish model may be pre-trained and subsequently fine-tuned during training to better encode information about the relative amounts of different instruments present in each channel, which may be useful for handling acoustic bleeds.

Following the audio embedding model 1006, the system may include a first transformer-encoder block 1008 that operates along the channels axis to learn inter-channel context related to instrument types. This transformer-encoder 1008 may use a multi-headed self-attention mechanism to capture relationships between different audio channels based on their embedded representations.

The system may then incorporate RMS conditioning 1010 by computing the Root Mean Square of the channel frames over the F2 frame size. The RMS information may be concatenated with the embeddings and processed through a projection layer with PReLU activation. This conditioning 1010 may provide level information that audio embedding models typically ignore but that may be important for mix parameter prediction.

A second transformer-encoder block 1012 may follow the RMS conditioning to learn inter-channel context relating to the relative levels of the input channels. This transformer-encoder may operate along the channels axis and may use similar multi-headed self-attention mechanisms as the first transformer-encoder.

The system may include a temporal processing block comprising a Gated Recurrent Unit (GRU) 1014 that operates along the temporal axis. The GRU 1014 may maintain information about previous audio frames and may be particularly useful for zero-latency processing where the model predicts mix parameters for future frames. The GRU 1014 may use a single layer with a hidden size of 128 neurons.

Following the temporal processing, the system may include a third transformer-encoder block 1016 that learns temporally-informed inter-channel context. This transformer-encoder may process the embeddings that have been informed by both inter-channel relationships and temporal dependencies.

The processed embeddings may then be input to a gain prediction network 1018 comprising a Multi-Layer Perceptron (MLP). The MLP may include multiple hidden layers, such as layers with 128, 64, and 32 neurons, followed by a uni-dimensional output layer corresponding to the predicted gain parameter. The hidden layers may use PReLU activation functions, while the final layer may use ReLU activation.

The predicted gains for all channels may be applied 1020 to the respective audio channel waveforms in apply gain blocks. The processed waveforms may then be summed together to obtain a resultant mono mix output 1022. All neural network components may share weights across all channels to ensure consistent processing.

The multi-rate processing capability may enable the system to extract longer frames for the audio embedding model while processing other features at shorter frame intervals. This approach may reduce system latency from the full F1 frame duration to the F2 frame duration, allowing for more responsive real-time processing while maintaining the temporal context required for accurate embedding generation.

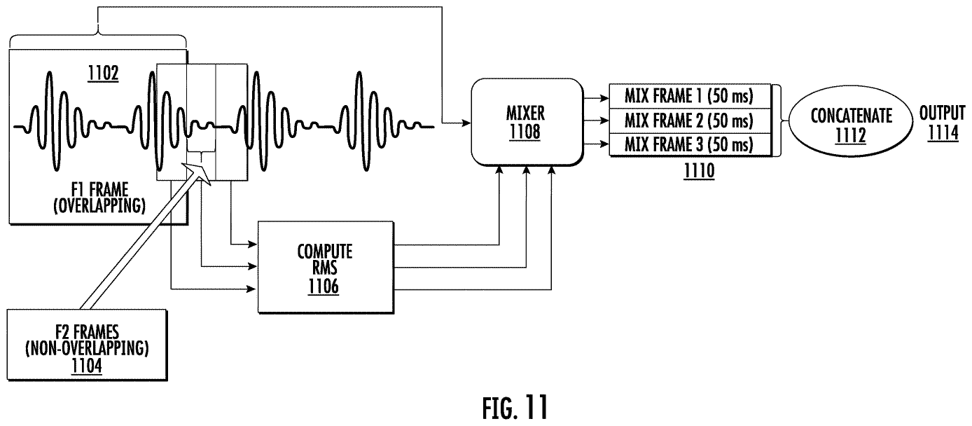

FIG. 11 illustrates example multi-rate processing for a single channel, according to embodiments of the present disclosure. FIG. 11 demonstrates the temporal relationship between different frame sizes used in the multi-rate processing architecture when setting F1 and F2 frame sizes to 975 milliseconds and 50 milliseconds respectively.

The processing begins with overlapping F1 frames 1102 of 975 milliseconds duration. These longer frames may be used to extract audio embeddings that require extended temporal context for accurate instrument identification and feature extraction. The F1 frames 1102 may overlap to ensure continuous processing coverage across the input audio signal.

From each F1 frame 1102, multiple non-overlapping F2 frames 1104 of 50 milliseconds duration may be extracted. In some cases, the F2 frames 1104 may be extracted starting from the last 50 milliseconds of the F1 frame 1102. This extraction pattern may allow the system to maintain temporal alignment while enabling faster processing of features that do not require the full temporal context of the F1 frame 1102.

The F2 frames 1104 may be used for computing features 1106 such as RMS levels and other rapidly changing characteristics that benefit from higher temporal resolution. These shorter frames may enable the system to respond more quickly to changes in the audio signal while still leveraging the longer-term context provided by the F1 frames 1102.

The multi-rate processing approach illustrated in FIG. 11 may allow the system to predict gains per F2 frame, resulting in several F2 frames of mixed 1108 audio output 1110. These output frames 1110 may then be concatenated together 1112 to obtain the final mixed audio stream 1114. The latency of the system may be reduced to the frame size of F2, which in this example corresponds to 50 milliseconds.

In some implementations, a new F1 frame may be extracted for every new F2 frame, which may involve striding the F1 frame by the size of the F2 frame. However, to manage computational load, the system may use the same F1 frame for several F2 frames before extracting a new F1 frame. For the specific case of F 2 frames being 50 milliseconds, the system may stride the F1 frame by 6 F2 frames, which corresponds to a stride duration of 300 milliseconds.

The temporal processing flow shown in FIG. 11 may enable efficient resource utilization by avoiding unnecessary recomputation of audio embeddings while still providing high temporal resolution for features that change rapidly. This approach may be particularly beneficial for zero-latency processing applications where minimizing prediction horizon is important for maintaining real-time performance.

### Zero Latency Processing

In some embodiments, the system may achieve zero latency processing by applying predicted mix parameters from a previous time frame to a current audio frame while predicting parameters for subsequent frames. The system may train the neural network to predict mix parameters for frames that are temporally offset from the current processing frame, such that the prediction for a future frame may be applied to the present frame being processed. This temporal offset approach may enable the system to maintain real-time processing without perceptible delay, and the multi-rate processing architecture may reduce the required prediction horizon compared to single-rate systems, thereby improving the accuracy of future parameter estimation.

### Training Data, Data Augmentation, Training Methods

The system may be trained using datasets that include multitrack recordings with corresponding ground truth mixes created by mixing engineers. In some cases, the training data may comprise songs with a limited number of raw tracks, such as eight or fewer channels, to maintain manageable computational complexity. The training dataset may be divided into training and validation sets, with care taken to ensure that no artist appears in both sets to prevent overfitting to specific musical styles or recording characteristics.

To address the challenge of limited naturally occurring bleed data in training datasets, the system may employ parametric data augmentation techniques that artificially simulate acoustic bleeds between instrument channels. The bleed simulation may utilize room acoustics modeling libraries to generate realistic cross-contamination scenarios that account for factors such as room dimensions, reverberation characteristics, performer positions, relative acoustic levels of different instruments, and microphone placement. These parameters may be randomized during training to create diverse bleed scenarios that encompass a wide range of live performance conditions. The system may also randomize input levels for all tracks during training to support robust performance across various input signal strengths.

The training process may utilize optimization algorithms with multi-step learning rate scheduling, where the learning rate may be reduced at predetermined intervals during training. The system may employ multi-resolution spectral loss functions that operate across multiple time scales to capture both short-term and long-term audio characteristics. For fine-tuning pre-trained audio embedding models, the system may initially freeze the embedding model weights for a portion of the training process before allowing joint optimization of all network parameters. This staged training approach may help preserve useful pre-trained features while adapting the model to the specific requirements of live mixing scenarios with acoustic bleeds.

FIG. 12 illustrates an example multi-mixing apparatus 1200 in accordance with at least some example embodiments of the present disclosure. The multi-mixing apparatus 1200 includes a processor 1202, input/output circuitry 1204, data storage media 1206, and communications circuitry 1208. In some embodiments, the multi-mixing apparatus 1200 is configured, using the processor 1202 and/or one or more of the sets of circuitry 1204, 1206, 1208, and/or 1210, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the multi-mixing apparatus 1200 provide or supplement the functionality of other particular sets of circuitry. For example, the processor 1202 in some embodiments provides processing functionality to any of the sets of circuitry, the data storage media 1206 provides storage functionality to any of the sets of circuitry, the communications circuitry 1208 provides network interface functionality to any of the sets of circuitry, and/or the like.

In some embodiments, the processor 1202 (and/or co-processor or any other processing circuitry assisting or otherwise associated with the processor 1202) is/are in communication with the data storage media 1206 via a bus for passing information among components of the multi-mixing apparatus 1200. In some embodiments, for example, the data storage media 1206 is non-transitory and may include, for example, one or more volatile and/or non-volatile memories. In other words, for example, the data storage media 1206 in some embodiments includes or embodies an electronic storage device (e.g., a computer readable storage medium). In some embodiments, the data storage media 1206 is configured to store information, data, content, applications, instructions, or the like, for enabling the multi-mixing apparatus 1200 to carry out various functions in accordance with example embodiments of the present disclosure.

The processor 1202 may be embodied in a number of different ways. For example, in some example embodiments, the processor 1202 includes one or more processing devices configured to perform independently. Additionally or alternatively, in some embodiments, the processor 1202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the multi-mixing apparatus 1200, and/or one or more remote or “cloud” processor(s) external to the multi-mixing apparatus 1200.

In an example embodiment, the processor 1202 is configured to execute instructions stored in the data storage media 1206 or otherwise accessible to the processor 1202. Alternatively or additionally, the processor 1202 in some embodiments is configured to execute hard-coded functionality. As such, whether configured by hardware or software methods, or by a combination thereof, the processor 1202 represents an entity (e.g., physically embodied in circuitry) capable of performing operations according to an embodiment of the present disclosure while configured accordingly. Alternatively or additionally, as another example in some example embodiments, when the processor 1202 is embodied as an executor of software instructions, the instructions specifically configure the processor 1202 to perform the algorithms embodied in the specific operations described herein when such instructions are executed.

In some embodiments, the multi-mixing apparatus 1200 includes the input/output circuitry 1204 that provides output to the user and, in some embodiments, to receive an indication of a user input. In some embodiments, the input/output circuitry 1204 is in communication with the processor 1202 to provide such functionality. The input/output circuitry 1204 may comprise one or more user interface(s) (e.g., user interface) and in some embodiments includes a display that comprises the interface(s) rendered as a web user interface, an application user interface, a user device, a backend system, or the like. The processor 1202 and/or the input/output circuitry 1204 comprising the processor 1202 may be configured to control one or more functions of one or more user interface elements through computer program instructions (e.g., software and/or firmware) stored on a memory accessible to the processor 1202 (e.g., the data storage media 1206, and/or the like). In some embodiments, the input/output circuitry 1204 includes or utilizes a user-facing application to provide input/output functionality to a client device and/or other display associated with a user.

In some embodiments, the multi-mixing apparatus 1200 includes the communications circuitry 1208. The communications circuitry 1208 includes any means such as a device or circuitry embodied in either hardware or a combination of hardware and software that is configured to receive and/or transmit data from/to a network and/or any other device, circuitry, or module in communication with the multi-mixing apparatus 1200. In this regard, the communications circuitry 1208 includes, for example in some embodiments, a network interface for enabling communications with a wired or wireless communications network. Additionally or alternatively in some embodiments, the communications circuitry 1208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 608 includes circuitry for interacting with the antenna(s) and/or other hardware or software to cause transmission of signals via the antenna(s) or to handle receipt of signals received via the antenna(s). In some embodiments, the communications circuitry 1208 enables transmission to and/or receipt of data from a client device in communication with the multi-mixing apparatus 1200.

With continued reference to FIG. 12, the multi-mixing apparatus 1200 includes multi-mixing circuitry 1210. The multi-mixing circuitry 1210 is configured to perform the operations of the multi-mixing apparatus 1200 as described herein.

Additionally or alternatively, in some embodiments, one or more of the sets of circuitry 1204-1210 are combinable. Additionally or alternatively, in some embodiments, one or more of the sets of circuitry perform some or all of the functionality described associated with another component. For example, in some embodiments, one or more sets of circuitry 1204-1210 are combined into a single module embodied in hardware, software, firmware, and/or a combination thereof. Similarly, in some embodiments, one or more of the sets of circuitry is/are combined such that the processor 1202 performs one or more of the operations described above with respect to each of these circuitry individually.

### CONCLUSION

While this detailed description has set forth some embodiments of the present invention, the appended claims cover other embodiments of the present invention which differ from the described embodiments according to various modifications and improvements. For example, one skilled in the art may recognize that such principles may be applied to any content capture and production system that utilizes multiple content capture devices to capture and process audio and visual content from live events based on an initial performance plan. For example, concerts, theatrical productions, podcasts, houses of worship services, meetings, interviews, cooking shows, sporting events, television productions, news broadcasts, film set recordings, and other staged or live events.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the at least one processor, to cause the apparatus to: receive a plurality of multichannel data streams; generate a plurality of per-channel embeddings by, for each multichannel data stream of the plurality of multichannel data streams, inputting the multichannel data stream into an embedding model and one or more projection layer to generate a per-channel embedding for the multichannel data stream; generate a plurality of inter-channel contextual embeddings by, for each per-channel embedding of the plurality of per-channel embeddings: inputting the plurality of per-channel embeddings into a contextual embedding model to generate an inter-channel contextual embedding for a respective multichannel data stream; generate a plurality of predicted mix parameters by inputting, to a mix parameter prediction network, the plurality of inter-channel contextual embeddings and global conditioning data; apply the plurality of predicted mix parameters to the plurality of multichannel data streams to generate one or more mixed output streams; and output the one or more mixed output streams.

Clause 2. An apparatus according to Clause 1, wherein, to generate the plurality of per-channel embeddings, the apparatus is further caused to, for each multichannel data stream of the plurality of multichannel data streams: input the multichannel data stream to the embedding model to generate one or more respective embeddings; input the one or more respective embeddings and one or more first stream features of the multichannel data stream associated with a first modification rate to a first projection layer to generate one or more first new respective embeddings; and input the one or more first new respective embeddings and one or more second stream features of the multichannel data stream associated with a second modification rate to a second projection layer to generate the per-channel embedding for the multichannel data stream.

Clause 3. An apparatus according to any of the foregoing Clauses, wherein the one or more first stream features comprise one or more of source identification, source location, or video location.

Clause 4. An apparatus according to any of the foregoing Clauses, wherein the one or more second stream features comprise one or more of RMS, spectral envelope, fundamental frequency, or other musical context.

Clause 5. An apparatus according to any of the foregoing Clauses, wherein a multichannel data stream of the plurality of multichannel data streams is associated with a raw data track.

Clause 6. An apparatus according to any of the foregoing Clauses, wherein the raw data track comprises one or more of raw audio data or raw video data.

Clause 7. An apparatus according to any of the foregoing Clauses, wherein the second modification rate is faster than the first modification rate.

Clause 8. An apparatus according to any of the foregoing Clauses, wherein the contextual embedding model generates the inter-channel contextual embedding for the respective multichannel data stream based on learned interactions among the plurality of per-channel embeddings.

Clause 9. An apparatus according to any of the foregoing Clauses, wherein the learned interactions represent interactions between the plurality of multichannel data streams.

Clause 10. An apparatus according to any of the foregoing Clauses, wherein the first modification rate is approximately every second and the second modification rate is approximately between every 20 milliseconds (ms) and 40 ms or between every 0 ms and 100 ms.

Clause 11. An apparatus according to any of the foregoing Clauses, wherein the global conditioning data comprises one or more of multichannel stream independent data or multichannel stream dependent data.

Clause 12. An apparatus according to any of the foregoing Clauses, wherein the multichannel stream independent data comprises one or more of a time-signature, a genre, venue information, or a reference audio signal recorded at a listener position.

Clause 13. An apparatus according to any of the foregoing Clauses, wherein the multichannel stream dependent data comprises one or more of a tag for lead, a tag for backup, a tonal tag, or a percussive tag.

Clause 14. An apparatus according to any of the foregoing Clauses, wherein the plurality of predicted mix parameters comprise one or more of gain, pan, EQ parameters, compression parameters, delay parameters, reverb parameters, or a predicted mask.

Clause 15. An apparatus according to any of the foregoing Clauses, wherein the one or more mixed output streams comprise one or more of a front of house (FoH) mix, a monitor mix, or a post-production mix.

Clause 16. An apparatus according to any of the foregoing Clauses, wherein the post-production mix comprises one or more of a mono mix, a stereo mix, a multichannel mix, or a spatial mix.

Clause 17. An apparatus according to any of the foregoing Clauses, wherein the plurality of predicted mix parameters are associated with a plurality of mix types.

Clause 18. An apparatus according to any of the foregoing Clauses, wherein the contextual embedding model comprises a transformer model and a temporal model.

Clause 19. An apparatus according to any of the foregoing Clauses, wherein the embedding model comprises a convolutional neural network.

Clause 20. An apparatus according to any of the foregoing Clauses, wherein the mix parameter prediction network comprises one or more dense layers with shared weights across channels.

Clause 21. An apparatus according to any of the foregoing Clauses, wherein the apparatus is further caused to: receive user input; and adjust one or more of the plurality of predicted mix parameters based on the user input.

Clause 22. An apparatus according to any of the foregoing Clauses, wherein the user input comprises one or more generative prompts and the apparatus is further caused to generate, in parallel, a plurality of output mixes based on the user input.

Clause 23. An apparatus according to any of the foregoing Clauses, wherein the apparatus is further caused to: generate a user interface for controlling the mixed output stream; and transmit the user interface to a remote device.

Clause 24. An apparatus according to any of the foregoing Clauses, wherein the plurality of multichannel data streams comprise audio and video data streams.

Clause 25. An apparatus according to any of the foregoing Clauses, wherein the apparatus is further caused to: apply source separation to the mixed output stream to obtain a plurality of isolated stems; and remix the isolated stems using generatively determined mix parameters.

Clause 26. An apparatus according to any of the foregoing Clauses, wherein the global conditioning data comprises information about a target output device for playback of the mixed output stream.

Clause 27. An apparatus according to any of the foregoing Clauses, wherein the contextual embedding model incorporates long-term dependencies between different multichannel data streams.

Clause 28. An apparatus according to any of the foregoing Clauses, wherein the apparatus is further caused to: adapt the predicted mix parameters in real-time based on feedback from an audio capture device in a performance space.

Clause 29. An apparatus according to any of the foregoing Clauses, wherein the apparatus is further caused to: attenuate bleeds or other unwanted noises before applying the plurality of predicted mix parameters to the plurality of multichannel data streams.

Clause 30. An apparatus according to any of the foregoing Clauses, wherein a first remote device applies the plurality of predicted mix parameters to the plurality of multichannel data streams.

Clause 31. An apparatus according to any of the foregoing Clauses, wherein one or more of the one or more mixed output streams is adjusted based at least in part on a listening capture device.

Clause 32. An apparatus according to any of the foregoing Clauses, wherein the listening capture device is one or more of a wireless microphone, a wireless mobile capture device, or an integrated capture device associated with a computing device.

Clause 33. An apparatus according to any of the foregoing Clauses, wherein the apparatus is further caused to apply the plurality of predicted mix parameters from a previous time frame to a current audio frame while predicting mix parameters for a subsequent frame to achieve zero latency processing.

Clause 34. An apparatus according to any of the foregoing Clauses, wherein the apparatus is further caused to train a neural network to predict mix parameters for frames that are temporally offset from a current processing frame.

Clause 35. An apparatus according to any of the foregoing Clauses, wherein the first modification rate corresponds to a first frame size and the second modification rate corresponds to a second frame size that is shorter than the first frame size to reduce prediction horizon for zero latency processing.

Clause 36. An apparatus according to any of the foregoing Clauses, wherein the first frame size is approximately 975 milliseconds and the second frame size is approximately 50 milliseconds.

Clause 37. An apparatus according to any of the foregoing Clauses, wherein the apparatus is further caused to extract multiple overlapping, non-overlapping, or a combination of overlapping and non-overlapping frames of the second frame size from each frame of the first frame size.

Clause 38. An apparatus according to any of the foregoing Clauses, wherein the temporal model comprises a recurrent neural network that maintains information about previous audio frames and/or context embeddings to enable prediction of future mix parameters.

Clause 39. An apparatus according to any of the foregoing Clauses, wherein the recurrent neural network comprises a gated recurrent unit.

Clause 40. An apparatus according to any of the foregoing Clauses, wherein zero latency processing maintains synchronization between audio and visual elements in live performance scenarios.

Clause 41. An apparatus according to any of the foregoing Clauses, wherein the apparatus is further caused to use a same frame of the first frame size for multiple frames of the second frame size before extracting a new frame of the first frame size.

Clause 42. An apparatus according to any of the foregoing Clauses, wherein the apparatus strides the frame of the first frame size by a duration corresponding to multiple frames of the second frame size.

Clause 43. A method comprising: receiving a plurality of multichannel data streams; generate a plurality of per-channel embeddings by, for each multichannel data stream of the plurality of multichannel data streams, inputting the multichannel data stream into an embedding model and one or more projection layer to generate a per-channel embedding for the multichannel data stream; generating a plurality of inter-channel contextual embeddings by, for each per-channel embedding of the plurality of per-channel embeddings: inputting the plurality of per-channel embeddings into a contextual embedding model to generate an inter-channel contextual embedding for a respective multichannel data stream; generating a plurality of predicted mix parameters by inputting, to a mix parameter prediction network, the plurality of inter-channel contextual embeddings and global conditioning data; applying the plurality of predicted mix parameters to the plurality of multichannel data streams to generate one or more mixed output streams; and outputting the one or more mixed output streams.

Clause 44. A method according to Clause 43, wherein generating the plurality of per-channel embeddings comprises: for each multichannel data stream of the plurality of multichannel data streams: inputting the multichannel data stream to the embedding model to generate one or more respective embeddings; inputting the one or more respective embeddings and one or more first stream features of the multichannel data stream associated with a first modification rate to a first projection layer to generate one or more first new respective embeddings; and inputting the one or more first new respective embeddings and one or more second stream features of the multichannel data stream associated with a second modification rate to a second projection layer to generate the per-channel embedding for the multichannel data stream.

Clause 45. A method according to any of the foregoing Clauses, wherein the one or more first stream features comprise one or more of source identification, source location, or video location.

Clause 46. A method according to any of the foregoing Clauses, wherein the one or more second stream features comprise one or more of RMS, spectral envelope, fundamental frequency, or other musical context.

Clause 47. A method according to any of the foregoing Clauses, wherein a multichannel data stream of the plurality of multichannel data streams is associated with a raw data track.

Clause 48. A method according to any of the foregoing Clauses, wherein the raw data track comprises one or more of raw audio data or raw video data.

Clause 49. A method according to any of the foregoing Clauses, wherein the second modification rate is faster than the first modification rate.

Clause 50. A method according to any of the foregoing Clauses, wherein the contextual embedding model generates the inter-channel contextual embedding for the respective multichannel data stream based on learned interactions among the plurality of per-channel embeddings.

Clause 51. A method according to any of the foregoing Clauses, wherein the learned interactions represent interactions between the plurality of multichannel data streams.

Clause 52. A method according to any of the foregoing Clauses, wherein the first modification rate is approximately every second and the second modification rate is approximately between every 20 milliseconds (ms) and 40 ms or between every 0 ms and 100 ms.

Clause 53. A method according to any of the foregoing Clauses, wherein the global conditioning data comprises one or more of multichannel stream independent data or multichannel stream dependent data.

Clause 54. A method according to any of the foregoing Clauses, wherein the multichannel stream independent data comprises one or more of a time-signature, a genre, venue information, or a reference audio signal recorded at a listener position.

Clause 55. A method according to any of the foregoing Clauses, wherein the multichannel stream dependent data comprises one or more of a tag for lead, a tag for backup, a tonal tag, or a percussive tag.

Clause 56. A method according to any of the foregoing Clauses, wherein the plurality of predicted mix parameters comprise one or more of gain, pan, EQ parameters, compression parameters, delay parameters, reverb parameters, or a predicted mask.

Clause 57. A method according to any of the foregoing Clauses, wherein the one or more mixed output streams comprise one or more of a front of house (FoH) mix, a monitor mix, or a post-production mix.

Clause 58. A method according to any of the foregoing Clauses, wherein the post-production mix comprises one or more of a mono mix, a stereo mix, a multichannel mix, or a spatial mix.

Clause 59. A method according to any of the foregoing Clauses, wherein the plurality of predicted mix parameters are associated with a plurality of mix types.

Clause 60. A method according to any of the foregoing Clauses, wherein the contextual embedding model comprises a transformer model and a temporal model.

Clause 61. A method according to any of the foregoing Clauses, wherein the embedding model comprises a convolutional neural network.

Clause 62. A method according to any of the foregoing Clauses, wherein the mix parameter prediction network comprises one or more dense layers with shared weights across channels.

Clause 63. A method according to any of the foregoing Clauses, further comprising: receiving user input; and adjustting one or more of the plurality of predicted mix parameters based on the user input.

Clause 64. A method according to any of the foregoing Clauses, wherein the user input comprises one or more generative prompts and the apparatus is further caused to generate, in parallel, a plurality of output mixes based on the user input.

Clause 65. A method according to any of the foregoing Clauses, further comprising: generating a user interface for controlling the mixed output stream; and transmit the user interface to a remote device.

Clause 66. A method according to any of the foregoing Clauses, wherein the plurality of multichannel data streams comprise audio and video data streams.

Clause 67. A method according to any of the foregoing Clauses, further comprising: applying source separation to the mixed output stream to obtain a plurality of isolated stems; and remixing the isolated stems using generatively determined mix parameters.

Clause 68. A method according to any of the foregoing Clauses, wherein the global conditioning data comprises information about a target output device for playback of the mixed output stream.

Clause 69. A method according to any of the foregoing Clauses, wherein the contextual embedding model incorporates long-term dependencies between different multichannel data streams.

Clause 70. A method according to any of the foregoing Clauses, further comprising: adapting the predicted mix parameters in real-time based on feedback from an audio capture device in a performance space.

Clause 71. A method according to any of the foregoing Clauses, further comprising: attenuating bleeds or other unwanted noises before applying the plurality of predicted mix parameters to the plurality of multichannel data streams.

Clause 72. A method according to any of the foregoing Clauses, wherein a first remote device applies the plurality of predicted mix parameters to the plurality of multichannel data streams.

Clause 73. A method according to any of the foregoing Clauses, wherein one or more of the one or more mixed output streams is adjusted based at least in part on a listening capture device.

Clause 74. A method according to any of the foregoing Clauses, wherein the listening capture device is one or more of a wireless microphone, a wireless mobile capture device, or an integrated capture device associated with a computing device.

Clause 75. A method according to any of the foregoing Clauses, wherein the apparatus is further caused to apply the plurality of predicted mix parameters from a previous time frame to a current audio frame while predicting mix parameters for a subsequent frame to achieve zero latency processing.

Clause 76. A method according to any of the foregoing Clauses, wherein the apparatus is further caused to train a neural network to predict mix parameters for frames that are temporally offset from a current processing frame.

Clause 77. A method according to any of the foregoing Clauses, wherein the first modification rate corresponds to a first frame size and the second modification rate corresponds to a second frame size that is shorter than the first frame size to reduce prediction horizon for zero latency processing.

Clause 78. A method according to any of the foregoing Clauses, wherein the first frame size is approximately 975 milliseconds and the second frame size is approximately 50 milliseconds.

Clause 79. A method according to any of the foregoing Clauses, further comprising: extracting multiple overlapping, non-overlapping, or a combination of overlapping and non-overlapping frames of the second frame size from each frame of the first frame size.

Clause 80. A method according to any of the foregoing Clauses, wherein the temporal model comprises a recurrent neural network that maintains information about previous audio frames and/or context embeddings to enable prediction of future mix parameters.

Clause 81. A method according to any of the foregoing Clauses, wherein the recurrent neural network comprises a gated recurrent unit.

Clause 82. A method according to any of the foregoing Clauses, wherein zero latency processing maintains synchronization between audio and visual elements in live performance scenarios.

Clause 83. A method according to any of the foregoing Clauses, further comprising: using a same frame of the first frame size for multiple frames of the second frame size before extracting a new frame of the first frame size.

Clause 84. A method according to any of the foregoing Clauses, further comprising: striding the frame of the first frame size by a duration corresponding to multiple frames of the second frame size.

Clause 85. A non-transitory computer-readable storage media storing instructions that, when executed by one or more processors, cause the one or more processors to: receive a plurality of multichannel data streams; generate a plurality of per-channel embeddings by, for each multichannel data stream of the plurality of multichannel data streams, inputting the multichannel data stream into an embedding model and one or more projection layer to generate a per-channel embedding for the multichannel data stream; generate a plurality of inter-channel contextual embeddings by, for each per-channel embedding of the plurality of per-channel embeddings: inputting the plurality of per-channel embeddings into a contextual embedding model to generate an inter-channel contextual embedding for a respective multichannel data stream; generate a plurality of predicted mix parameters by inputting, to a mix parameter prediction network, the plurality of inter-channel contextual embeddings and global conditioning data; apply the plurality of predicted mix parameters to the plurality of multichannel data streams to generate one or more mixed output streams; and output the one or more mixed output streams.

Clause 86. A non-transitory computer-readable storage media according to Clause 85, wherein, to generate the plurality of per-channel embeddings, the one or more processors are further caused to, for each multichannel data stream of the plurality of multichannel data streams: input the multichannel data stream to the embedding model to generate one or more respective embeddings; input the one or more respective embeddings and one or more first stream features of the multichannel data stream associated with a first modification rate to a first projection layer to generate one or more first new respective embeddings; and input the one or more first new respective embeddings and one or more second stream features of the multichannel data stream associated with a second modification rate to a second projection layer to generate the per-channel embedding for the multichannel data stream.

Clause 87. A non-transitory computer-readable storage media according to any of the foregoing Clauses, wherein the one or more first stream features comprise one or more of source identification, source location, or video location.

Clause 88. A non-transitory computer-readable storage media according to any of the foregoing Clauses, wherein the one or more second stream features comprise one or more of RMS, spectral envelope, fundamental frequency, or other musical context.

Clause 89. A non-transitory computer-readable storage media according to any of the foregoing Clauses, wherein a multichannel data stream of the plurality of multichannel data streams is associated with a raw data track.

Clause 90. A non-transitory computer-readable storage media according to any of the foregoing Clauses, wherein the raw data track comprises one or more of raw audio data or raw video data.

Clause 91. A non-transitory computer-readable storage media according to any of the foregoing Clauses, wherein the second modification rate is faster than the first modification rate.

Clause 92. A non-transitory computer-readable storage media according to any of the foregoing Clauses, wherein the contextual embedding model generates the inter-channel contextual embedding for the respective multichannel data stream based on learned interactions among the plurality of per-channel embeddings.

Clause 93. A non-transitory computer-readable storage media according to any of the foregoing Clauses, wherein the learned interactions represent interactions between the plurality of multichannel data streams.

Clause 94. A non-transitory computer-readable storage media according to any of the foregoing Clauses, wherein the first modification rate is approximately every second and the second modification rate is approximately between every 20 milliseconds (ms) and 40 ms or between every 0 ms and 100 ms.

Clause 95. A non-transitory computer-readable storage media according to any of the foregoing Clauses, wherein the global conditioning data comprises one or more of multichannel stream independent data or multichannel stream dependent data.

Clause 96. A non-transitory computer-readable storage media according to any of the foregoing Clauses, wherein the multichannel stream independent data comprises one or more of a time-signature, a genre, venue information, or a reference audio signal recorded at a listener position.

Clause 97. A non-transitory computer-readable storage media according to any of the foregoing Clauses, wherein the multichannel stream dependent data comprises one or more of a tag for lead, a tag for backup, a tonal tag, or a percussive tag.

Clause 98. A non-transitory computer-readable storage media according to any of the foregoing Clauses, wherein the plurality of predicted mix parameters comprise one or more of gain, pan, EQ parameters, compression parameters, delay parameters, reverb parameters, or a predicted mask.

Clause 99. A non-transitory computer-readable storage media according to any of the foregoing Clauses, wherein the one or more mixed output streams comprise one or more of a front of house (FoH) mix, a monitor mix, or a post-production mix.

Clause 100. A non-transitory computer-readable storage media according to any of the foregoing Clauses, wherein the post-production mix comprises one or more of a mono mix, a stereo mix, a multichannel mix, or a spatial mix.

Clause 101. A non-transitory computer-readable storage media according to any of the foregoing Clauses, wherein the plurality of predicted mix parameters are associated with a plurality of mix types.

Clause 102. A non-transitory computer-readable storage media according to any of the foregoing Clauses, wherein the contextual embedding model comprises a transformer model and a temporal model.

Clause 103. A non-transitory computer-readable storage media according to any of the foregoing Clauses, wherein the embedding model comprises a convolutional neural network.

Clause 104. A non-transitory computer-readable storage media according to any of the foregoing Clauses, wherein the mix parameter prediction network comprises one or more dense layers with shared weights across channels.

Clause 105. A non-transitory computer-readable storage media according to any of the foregoing Clauses, wherein the one or more processors are further caused to: receive user input; and adjust one or more of the plurality of predicted mix parameters based on the user input.

Clause 106. A non-transitory computer-readable storage media according to any of the foregoing Clauses, wherein the user input comprises one or more generative prompts and the apparatus is further caused to generate, in parallel, a plurality of output mixes based on the user input.

Clause 107. A non-transitory computer-readable storage media according to any of the foregoing Clauses, wherein the one or more processors are further caused to: generate a user interface for controlling the mixed output stream; and transmit the user interface to a remote device.

Clause 108. A non-transitory computer-readable storage media according to any of the foregoing Clauses, wherein the plurality of multichannel data streams comprise audio and video data streams.

Clause 109. A non-transitory computer-readable storage media according to any of the foregoing Clauses, wherein the one or more processors are further caused to: apply source separation to the mixed output stream to obtain a plurality of isolated stems; and remix the isolated stems using generatively determined mix parameters.

Clause 110. A non-transitory computer-readable storage media according to any of the foregoing Clauses, wherein the global conditioning data comprises information about a target output device for playback of the mixed output stream.

Clause 111. A non-transitory computer-readable storage media according to any of the foregoing Clauses, wherein the contextual embedding model incorporates long-term dependencies between different multichannel data streams.

Clause 112. A non-transitory computer-readable storage media according to any of the foregoing Clauses, wherein the one or more processors are further caused to: adapt the predicted mix parameters in real-time based on feedback from an audio capture device in a performance space.

Clause 113. A non-transitory computer-readable storage media according to any of the foregoing Clauses, wherein the one or more processors are further caused to: attenuate bleeds or other unwanted noises before applying the plurality of predicted mix parameters to the plurality of multichannel data streams.

Clause 114. A non-transitory computer-readable storage media according to any of the foregoing Clauses, wherein a first remote device applies the plurality of predicted mix parameters to the plurality of multichannel data streams.

Clause 115. A non-transitory computer-readable storage media according to any of the foregoing Clauses, wherein one or more of the one or more mixed output streams is adjusted based at least in part on a listening capture device.

Clause 116. A non-transitory computer-readable storage media according to any of the foregoing Clauses, wherein the listening capture device is one or more of a wireless microphone, a wireless mobile capture device, or an integrated capture device associated with a computing device.

Clause 117. A non-transitory computer-readable storage media according to any of the foregoing Clauses, wherein the one or more processors are further caused to apply the plurality of predicted mix parameters from a previous time frame to a current audio frame while predicting mix parameters for a subsequent frame to achieve zero latency processing.

Clause 118. A non-transitory computer-readable storage media according to any of the foregoing Clauses, wherein the one or more processors are further caused to train a neural network to predict mix parameters for frames that are temporally offset from a current processing frame.

Clause 119. A non-transitory computer-readable storage media according to any of the foregoing Clauses, wherein the first modification rate corresponds to a first frame size and the second modification rate corresponds to a second frame size that is shorter than the first frame size to reduce prediction horizon for zero latency processing.

Clause 120. A non-transitory computer-readable storage media according to any of the foregoing Clauses, wherein the first frame size is approximately 975 milliseconds and the second frame size is approximately 50 milliseconds.

Clause 121. A non-transitory computer-readable storage media according to any of the foregoing Clauses, wherein the one or more processors are further caused to extract multiple overlapping, non-overlapping, or a combination of overlapping and non-overlapping frames of the second frame size from each frame of the first frame size.

Clause 122. A non-transitory computer-readable storage media according to any of the foregoing Clauses, wherein the temporal model comprises a recurrent neural network that maintains information about previous audio frames and/or context embeddings to enable prediction of future mix parameters.

Clause 123. A non-transitory computer-readable storage media according to any of the foregoing Clauses, wherein the recurrent neural network comprises a gated recurrent unit.

Clause 124. A non-transitory computer-readable storage media according to any of the foregoing Clauses, wherein zero latency processing maintains synchronization between audio and visual elements in live performance scenarios.

Clause 125. A non-transitory computer-readable storage media according to any of the foregoing Clauses, wherein the one or more processors are further caused to use a same frame of the first frame size for multiple frames of the second frame size before extracting a new frame of the first frame size.

Clause 126. A non-transitory computer-readable storage media according to any of the foregoing Clauses, wherein the one or more processors are caused to stride the frame of the first frame size by a duration corresponding to multiple frames of the second frame size.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising at least one processor and a memory storing instructions that are operable, when executed by the at least one processor, to cause the apparatus to:
receive a plurality of multichannel data streams;
generate a plurality of per-channel embeddings by, for each multichannel data stream of the plurality of multichannel data streams, inputting the multichannel data stream into an embedding model and one or more projection layer to generate a per-channel embedding for the multichannel data stream;
generate a plurality of inter-channel contextual embeddings by, for each per-channel embedding of the plurality of per-channel embeddings, inputting the plurality of per-channel embeddings into a contextual embedding model to generate an inter-channel contextual embedding for a respective multichannel data stream;
generate a plurality of predicted mix parameters by inputting, to a mix parameter prediction network, the plurality of inter-channel contextual embeddings and global conditioning data;
apply the plurality of predicted mix parameters to the plurality of multichannel data streams to generate one or more mixed output streams; and
output the one or more mixed output streams.

2. The apparatus of claim 1, wherein, to generate the plurality of per-channel embeddings, the apparatus is further caused to, for each multichannel data stream of the plurality of multichannel data streams:
input the multichannel data stream to the embedding model to generate one or more respective embeddings;
input the one or more respective embeddings and one or more first stream features of the multichannel data stream associated with a first modification rate to a first projection layer to generate one or more first new respective embeddings; and
input the one or more first new respective embeddings and one or more second stream features of the multichannel data stream associated with a second modification rate to a second projection layer to generate the per-channel embedding for the multichannel data stream.

3. The apparatus of claim 2, wherein the one or more first stream features comprise one or more of source identification, source location, or video location.

4. The apparatus of claim 2, wherein the one or more second stream features comprise one or more of RMS, spectral envelope, fundamental frequency, or other musical context.

5. The apparatus of claim 1, wherein a multichannel data stream of the plurality of multichannel data streams is associated with a raw data track.

6. The apparatus of claim 5, wherein the raw data track comprises one or more of raw audio data or raw video data.

7. The apparatus of claim 2, wherein the second modification rate is faster than the first modification rate.

8. The apparatus of claim 1, wherein the contextual embedding model generates the inter-channel contextual embedding for the respective multichannel data stream based on learned interactions among the plurality of per-channel embeddings.

9. The apparatus of claim 8, wherein the learned interactions represent interactions between the plurality of multichannel data streams.

10. The apparatus of claim 2, wherein the first modification rate is approximately every second and the second modification rate is approximately between every 20 milliseconds (ms) and 40 ms or between every 0ms and 100ms.

11. The apparatus of claim 1, wherein the global conditioning data comprises one or more of multichannel stream independent data or multichannel stream dependent data.

12. The apparatus of claim 11, wherein the multichannel stream independent data comprises one or more of a time-signature, a genre, venue information, or a reference audio signal recorded at a listener position.

13. (canceled)

14. The apparatus of claim 1, wherein the plurality of predicted mix parameters comprise one or more of gain, pan, EQ parameters, compression parameters, delay parameters, reverb parameters, or a predicted mask.

15. The apparatus of claim 1, wherein the one or more mixed output streams comprise one or more of a front of house (FoH) mix, a monitor mix, or a post-production mix.

16. The apparatus of claim 15, wherein the post-production mix comprises one or more of a mono mix, a stereo mix, a multichannel mix, or a spatial mix.

17. The apparatus of claim 1, wherein the plurality of predicted mix parameters are associated with a plurality of mix types.

18. The apparatus of claim 1, wherein the contextual embedding model comprises a transformer model and a temporal model.

19. The apparatus of claim 1, wherein the embedding model comprises a convolutional neural network.

20. The apparatus of claim 1, wherein the mix parameter prediction network comprises one or more dense layers with shared weights across channels.

21. (canceled)

22. The apparatus of claim 1, wherein the apparatus is further caused to:
receive user input; and
adjust one or more of the plurality of predicted mix parameters based on the user input, wherein the user input comprises one or more generative prompts and the apparatus is further caused to generate, in parallel, a plurality of output mixes based on the user input.

23-44. (canceled)
